(19) United States
(12) Patent Application Publication
(10) Pub. No.: US 2016/0104113 A1
(43) Pub. Date: Apr. 14, 2016

(54) Peer to Peer Delivery System

(71) Applicant: Marc Gorlin, Atlanta, GA (US)

(72) Inventor: Marc Gorlin, Atlanta, GA (US)

(21) Appl. No.: 14/512,961

(22) Filed: Oct. 13, 2014

(51) Int. Cl. G06Q 10/08

(52) U.S. Cl. CPC G06Q 10/08355

(57) ABSTRACT

A method, apparatus, and computer readable storage to implement an N-tier application package delivery service. Drivers can register for the system and then be presented with automatic alerts when pick up points (for delivery tasks) are nearby or along their current route so that drivers can make extra money by picking packages that are available on or near their current route and then deliver them. Driving patterns of each driver are detected, stored, and analyzed so that their destinations can automatically be predicted.

### BACKGROUND OF THE INVENTION

1. Field of the Invention

The present general inventive concept is directed to a method, apparatus, and computer readable storage medium directed to implementing a peer to peer delivery system.

2. Description of the Related Art

Courier delivery systems exist in which a person can (for a fee) have a package delivered by a private company (outside of the US mail system). Large scale courier companies have rigid schedules of when their vehicles will travel to certain destinations and areas.

What is needed is a more flexible system which can tailor deliveries on a case by case or direct point to point basis.

### SUMMARY OF THE INVENTION

It is an aspect of the present invention to provide an improved delivery system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of maintaining a database of drivers and their current locations, according to an embodiment;

FIG. 2 is a flowchart illustrating an exemplary method of selecting a deliverer, according to an embodiment;

FIG. 3 is a flowchart illustrating an exemplary method of initiating a delivery of the package from the sender to the receiver, according to an embodiment;

FIG. 4 is a flowchart illustrating an exemplary method of completing the delivery of the package from the sender to the receiver, according to an embodiment;

FIG. 5 is a block diagram illustrating participants of the system on a computer communications network, according to an embodiment;

FIG. 6 is an example of a dialogue box which illustrates a request for a delivery task made by a sender, according to an embodiment;

FIG. 7 is an example of a dialogue box which illustrates a request to a potential deliverer to make a delivery, according to an embodiment;

FIG. 8 is an example of a dialogue box which illustrates a confirmation query so the sender can approve the selection of the potential deliverer, according to an embodiment;

FIG. 9 is a sample heads up map display that can be displayed on a driver's output device, according to an embodiment;

FIG. 10 is a an exemplary flowchart illustrating an updating of the driver's output display, according to an embodiment;

FIG. 11 is an exemplary flowchart illustrating an acceptance of a delivery task, according to an embodiment;

FIG. 12 is a flowchart illustrating an exemplary method of verifying a delivery, according to an embodiment;

FIG. 13 is a flowchart illustrating an exemplary method of verifying a delivery using a bar code, according to an embodiment;

FIG. 14 is a flowchart illustrating an exemplary method of verifying a delivery using near field communication, according to an embodiment;

FIG. 15 illustrates a delivery verification method that does not require a smart-phone, according to an embodiment;

FIG. 16 is a flowchart illustrating an exemplary method of tracking and recording driver locations, according to an embodiment;

FIG. 17 is a flowchart illustrating an exemplary method of populating a destination list, according to an embodiment;

FIG. 18 is a flowchart illustrating an exemplary method of identifying delivery tasks based on predictive routes, according to an embodiment;

FIG. 19 is a sample pop-up message that can be displayed on driver's computing device prompting him or her whether to accept a compatible delivery task, according to an embodiment;

FIG. 20 is a drawing of an example destination heat map, according to an embodiment;

FIG. 21 is a flowchart illustrating an exemplary method of implementing a consolidation route, according to an embodiment;

FIG. 22 is a flowchart illustrating how a consolidation route is determined, according to an embodiment;

FIG. 23 is an example of a dialogue box which illustrates a driver's request for a consolidation route, according to an embodiment;

FIG. 24 is an example of an output window showing proposed consolidation routes, according to an embodiment;

FIG. 25 is a flowchart illustrating an exemplary method of implementing a distress network, according to an embodiment;

FIG. 26 is a block diagram illustrating one example of computer hardware that can be used to implement any computer used, according to an embodiment;

FIG. 27 is a block diagram illustrating the system and more particularly a production system, according to an embodiment;

FIG. 28 is an exemplary mobile device screen illustrating a default home view, according to an embodiment.

FIG. 29 is an exemplary mobile device screen illustrating a default home view with task information selected and highlighted, according to an embodiment.

FIG. 30 is an exemplary mobile device screen illustrating a default home view with task data graphically displayed, according to an embodiment.

FIG. 31 is an exemplary mobile device screen illustrating a task list view, according to an embodiment.

FIG. 32 is an exemplary mobile device screen illustrating a filtering screen for a mapping screen, according to an embodiment.

FIG. 33 is an exemplary mobile device screen illustrating a task detail summary screen, according to an embodiment.

FIG. 34 is an exemplary mobile device screen illustrating one aspect of a task creation, according to an embodiment.

FIG. 35 is an exemplary mobile device screen illustrating another aspect of a task creation, according to an embodiment.

FIG. 36 is an exemplary mobile device screen illustrating a further aspect of a task creation, according to an embodiment.

FIG. 37 is an exemplary mobile device screen illustrating an additional aspect of a task creation, according to an embodiment.

FIG. 38 is an exemplary mobile device screen illustrating a user's task list, according to an embodiment.

FIG. 39 is an exemplary mobile device screen illustrating a task acceptance screen, according to an embodiment.

FIG. 40 is an exemplary mobile device screen illustrating a messaging system between a driver and a requestor (or any two parties), according to an embodiment.

FIG. 41 is an exemplary mobile device screen illustrating a login or registration screen if the user is a social media user, according to an embodiment.

FIG. 42 is an exemplary mobile device screen illustrating a login screen if the user is not a social media user, according to an embodiment.

FIG. 43 is an exemplary mobile device screen illustrating a user information entry screen, according to an embodiment.

FIG. 44 is an exemplary mobile device screen illustrating a verification screen, according to an embodiment.

FIG. 45 is an exemplary mobile device screen illustrating a screen to capture a sender's driver's license information, according to an embodiment.

FIG. 46 is an exemplary mobile device screen illustrating a screen to capture a sender's credit card information to make payment to the system, according to an embodiment.

FIG. 47 is an exemplary mobile device screen illustrating a welcome screen for a new user who has successfully registered, according to an embodiment.

FIG. 48 is an exemplary mobile device screen illustrating an incomplete registration screen, according to an embodiment.

FIG. 49 is an exemplary mobile device screen illustrating scanning of a driver's license information (e.g., using a cell phone camera), according to an embodiment.

FIG. 50 is an exemplary mobile device screen illustrating a vehicle information entry screen, according to an embodiment.

FIG. 51 is an exemplary mobile device screen illustrating a checking information entry screen to make payment, according to an embodiment.

FIG. 52 is an exemplary mobile device screen illustrating a successful verification screen, according to an embodiment.

FIG. 53 is an exemplary mobile device screen illustrating an unsuccessful verification screen, according to an embodiment.

FIG. 54 is an exemplary mobile device screen illustrating an incomplete user information screen, according to an embodiment.

FIG. 55 is an exemplary mobile device screen illustrating a task information screen displaying pickup information for a driver, according to an embodiment.

FIG. 56 is an exemplary mobile device screen illustrating an alert notification screen for a driver during a task, according to an embodiment.

FIG. 57 is an exemplary mobile device screen illustrating a pickup confirmation screen for a driver, according to an embodiment.

FIG. 58 is an exemplary mobile device screen illustrating a delivery location screen for a driver, according to an embodiment.

FIG. 59 is an exemplary mobile device screen illustrating a delivery confirmation screen for a driver, according to an embodiment.

FIG. 60 is an exemplary mobile device screen illustrating a delivery code entry screen for a driver, according to an embodiment.

FIG. 61 is an exemplary mobile device screen illustrating a rating screen for a sender (or receiver), according to an embodiment.

FIG. 62 is an exemplary mobile device screen illustrating a commenting screen for a driver, according to an embodiment.

FIG. 63 is an exemplary mobile device screen illustrating a task information screen displaying pickup information for a sender, according to an embodiment.

FIG. 64 is an exemplary mobile device screen illustrating a task information screen displaying estimated time of arrival information for a sender, according to an embodiment.

FIG. 65 is an exemplary mobile device screen illustrating a pickup conformation screen for a sender, according to an embodiment.

FIG. 66 is an exemplary mobile device screen illustrating a delivery location screen for a sender, according to an embodiment.

FIG. 67 is an exemplary mobile device screen illustrating a delivery confirmation screen for a sender, according to an embodiment.

FIG. 68 is an exemplary mobile device screen illustrating a rating screen for a sender to rate the driver, according to an embodiment.

FIG. 69 is an exemplary mobile device screen illustrating a task information screen, according to an embodiment.

FIG. 70 is an exemplary mobile device screen illustrating an estimated delivery time, according to an embodiment.

FIG. 71 is an exemplary mobile device screen illustrating a delivery location screen, according to an embodiment.

FIG. 72 is an exemplary mobile device screen illustrating a delivery notification screen for the receiver, according to an embodiment.

FIG. 73 is an exemplary mobile device screen illustrating a driver's profile screen, according to an embodiment.

FIG. 74 is an exemplary mobile device screen illustrating a driver's vehicles screen, according to an embodiment.

FIG. 75 is an exemplary mobile device screen illustrating a sender's profile screen, according to an embodiment.

FIG. 76 is an exemplary mobile device screen illustrating a driver's profile information screen from a sender's view, according to an embodiment.

FIG. 77 is an exemplary mobile device screen illustrating a profile editing screen, according to an embodiment.

FIG. 78 is an exemplary mobile device screen illustrating a second portion of a profile editing screen, according to an embodiment.

FIG. 79 is an exemplary mobile device screen illustrating a phone number editing screen with SMS verification, according to an embodiment.

FIG. 80 is an exemplary mobile device screen illustrating a password editing screen, according to an embodiment.

FIG. 81 is an exemplary mobile device screen illustrating a checking information editing screen, according to an embodiment.

FIG. 82 is an exemplary mobile device screen illustrating a driver's license information editing screen for a driver, according to an embodiment.

FIG. 83 is an exemplary mobile device screen illustrating an insurance information editing screen for a driver, according to an embodiment.

FIG. 84 is an exemplary mobile device screen illustrating a vehicle information editing screen for a driver, according to an embodiment.

FIG. 85 is an exemplary mobile device screen illustrating a new vehicle information input screen for a driver, according to an embodiment.

FIG. 86 is an exemplary mobile device screen illustrating a personal information input screen for a driver, according to an embodiment.

FIG. 87 is an exemplary mobile device screen illustrating a route information editing screen for a driver, according to an embodiment.

FIG. 88 is an exemplary mobile device screen illustrating a new route information input screen for a driver, according to an embodiment.

FIG. 89 is an exemplary mobile device screen illustrating a driver information screen, according to an embodiment.

FIG. 90 is an exemplary mobile device screen illustrating payment verification screen for ACH authorization so the driver can receive payment for completed tasks, according to an embodiment.

FIG. 91 is an exemplary mobile device screen illustrating an incorrect entering of verification information, according to an embodiment.

FIG. 92 is an exemplary mobile device screen illustrating a correct entering of verification information, according to an embodiment.

FIG. 93 is an exemplary mobile device screen illustrating a checking information editing screen for ACH authorization, according to an embodiment.

FIG. 94 is an exemplary mobile device screen illustrating checking account verification, according to an embodiment.

FIG. 95 is an exemplary mobile device screen illustrating a task information and selection screen, according to an embodiment.

FIG. 96 is an exemplary mobile device screen illustrating a vehicle selection screen, according to an embodiment.

FIG. 97 is an exemplary mobile device screen illustrating a task confirmation screen, according to an embodiment.

FIG. 98 is an exemplary mobile device screen illustrating an assigned task list screen, according to an embodiment.

FIG. 99 is an exemplary mobile device screen illustrating of a detailed task display, according to an embodiment.

FIG. 100 is an exemplary mobile device screen illustrating a task cancellation screen, according to an embodiment.

FIG. 101 is an exemplary mobile device screen illustrating a task cancellation screen for a Roadie, according to an embodiment.

FIG. 102 is an exemplary mobile device screen illustrating a task that has been cancelled by a sender, according to an embodiment.

FIG. 103 is an exemplary mobile device screen illustrating a pop-up notification that a task has been cancelled by a sender, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement an N-Tier backed delivery (also referred to as “peer to peer”) system (“system”). A user (e.g., sender, receiver, manager) can log into the system using their mobile device or any web browser, request that a package be picked up at a certain location and dropped off at a certain location, and the system will locate a group of suitable drivers and present the option for the sender and receiver (recipient) to double accept (both agree to terms of trip and price although in another embodiment only one party needs to accept the price since they would be paying), and arrange for the package to be picked up and delivered. Note that the pool of drivers in this system are not employees of the system or required to be part of any organization (other than a registered user of the system itself) but just regular people going about the common driving patterns and places of their daily lives, and they can make deliveries using the system on a part time basis whenever they want.

When a user (sender, receiver, manager) makes a new request to send (deliver) a package, the system first identifies all of the potential participating drivers and their locations in order to identify which drivers are the best candidates for being the driver for this particular request. Then, and the request will then be broadcast to all drivers based on location and availability in addition to being queried by potential drivers if none are available at the moment.

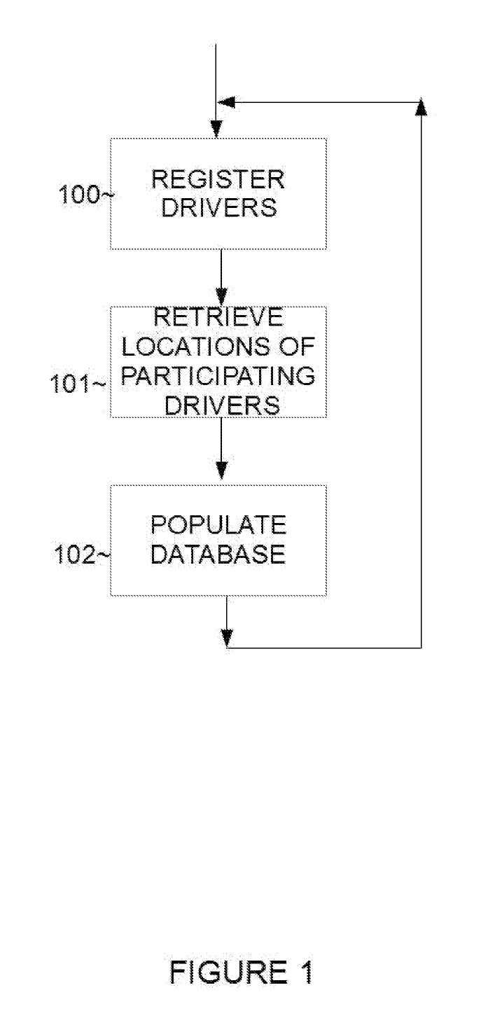

FIG. 1 is a flowchart illustrating an exemplary method of maintaining a database of drivers and their current locations, according to an embodiment.

The method can begin with operation 100, which registers drivers (and others). Drivers are people who register with the system (using a mobile application or a web browser). In order to be able to deliver packages using the system, a person would have to register an account (sign up) with system (e.g., receivers, drivers, managers and senders would need to have accounts). In an embodiment, senders (senders) and/or receivers would not need to register an account, they can simply use a web site (or web links) to enter their shipment information without registering an account (e.g., they are a “guest”) and web links and text messages can be used to guarantee identify and chain of custody of a package. The registration process will input personal identifying information, such as the driver's name, address, business address, vacation home address, other typical trip destinations, type of vehicle, hours available to deliver, etc. The system may (optionally, depending on the embodiment) verify this information (for example using a background verification service) and may also optionally check to see if the driver has a criminal background (no criminal convictions may be required in order to be approved to be a driver). All of this information is stored in the user's account. There is no limit to the number of drivers that can register with the system. The system would maintain a database of all of the registered drivers. Operation 100 can repeat itself, that is, new drivers can continuously register accounts on the system.

Separate from operation 100, operation 101 is performed which retrieves the locations of all drivers. Not all drivers may be participating at the current time. For example, a driver can indicate hours for each day that the driver's account would be considered participating. If a driver is not currently participating then the driver would not receive real time requests (or alerts) from the system (in other words he “opts out”). If the driver is currently participating, then the driver would receive any real time requests (or alerts) from the system. Note that all drivers (“drivers” refers to drivers that have an account with the system) can be participating or non-participating, and the driver can set his/her preferences as to when the driver wishes to be participating (where he/she can receive automatic notifications about potential package deliveries on their predicted routes) and non-participating (still a member of the system but will not receive notifications). Drivers can tell the system on a daily basis how much time/distance they would be willing to drive (or go out of their way) on a given day (or just in general) to deliver a package.

The locations of the participating drivers can be determining using any known location technology (or combination thereof), such as GPS, Wi-Fi, cell towers, etc. For example, the device's (which is on or near the driver) location can be determined using that device's GPS device (or any other technology such as Wi-Fi identification, etc.) which can then be transmitted (“location updates”) to the server using that device's wireless communication system (for example a text message can be sent to the server identifying the device and its current location in GPS coordinates), or any other transmission protocols can be used as well. Each driver's portable device would transmit its location to the server periodically (e.g., every minute, 10 seconds, etc.) Note that in some cases, the frequency a mobile devices transmits its location would vary based on its circumstances. For example, if its battery level is low, then the frequency of transmission can be reduced (e.g., from once every 10 seconds to once a minute, etc.) in order to preserve battery life. Other factors such as time and/or speed can also be factors in the frequency of location updates. For example, of the driver (and hence his/her portable device) is stationary or moving slowly, then it is not necessary to update his/her location frequently and thus the updates can be made with less frequency to preserve battery life. If the driver is moving quickly (or on a highway), then location updates can be made more frequently. In a further embodiment, available bandwidth would be a factor in determining how frequently location updates would be sent. If a portable device has high bandwidth, then location updates can be transmitted more frequently than if it has low bandwidth. In addition, the type of connection can be considered when determining how frequently to send location updates. A mobile computing device connected to Wi-Fi would be programmed to send more frequent updates than if no Wi-Fi were available and the cellular wireless signal would have to be used (which can be more costly in terms of battery life and possible cellular charges from the carrier as well). A combination of any number of these factors (location, speed, bandwidth, type of signal, etc.) can be utilized in determining the update frequency. In an embodiment, a “geofence” can be set up. A geofence is a virtual area around a driver (e.g., 100 square feet around a current location of the driver). As long as the driver does not exit the geofence area, then no location update would be sent from the driver (who would always have his portable device located on him/her) to the server. Once the driver exits the geofence area, then location updates would start being sent from the driver's portable computing device to the server. The portable computing device itself would locate itself periodically and determine whether it left the geofence or not, but this would not require additional battery power to send the location update to the server. Thus, in this way, the geofence (which can, for example be set up around a driver's home or office) would help reduce the amount of location updates transmitted from the portable computing device to the server.

From operation 101, the method proceeds to operation 102 which populates the database. The current locations are stored in the database associated with their respective driver.

From operation 102, the method returns to operation 101, which continues to retrieve locations of drivers, retrieving the locations and populating the database. The method illustrated in FIG. 1 (e.g., operation 100 and operations 101-102) can continue running indefinitely (e.g., 24 hours a day) so that the database has a current list of all participating drivers and their locations as well as the likely next stops from those locations.

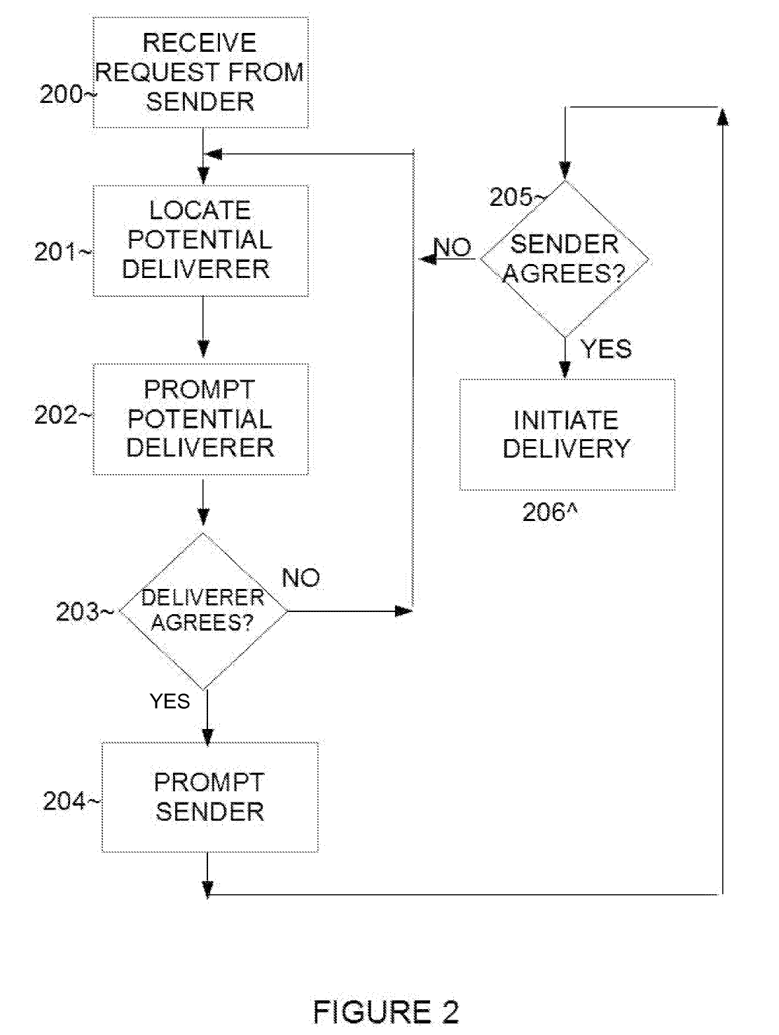

FIG. 2 is a flowchart illustrating an exemplary method of selecting a deliverer, according to an embodiment. A deliverer is the driver that is going to make the actual delivery of the package. The deliverer is selected out of all of the participating drivers as the most logical driver for the job. In one embodiment, the deliver that is selected can take on the task without the sender's approval, while in another embodiment the sender (sender) would need to approve the assignment of the particular deliverer for the task. A plurality of potential deliverers can be selected (the best ones for the task) and the sender (or manager or receiver) can select which of the potential deliverers he/she wishes to utilize for the task.

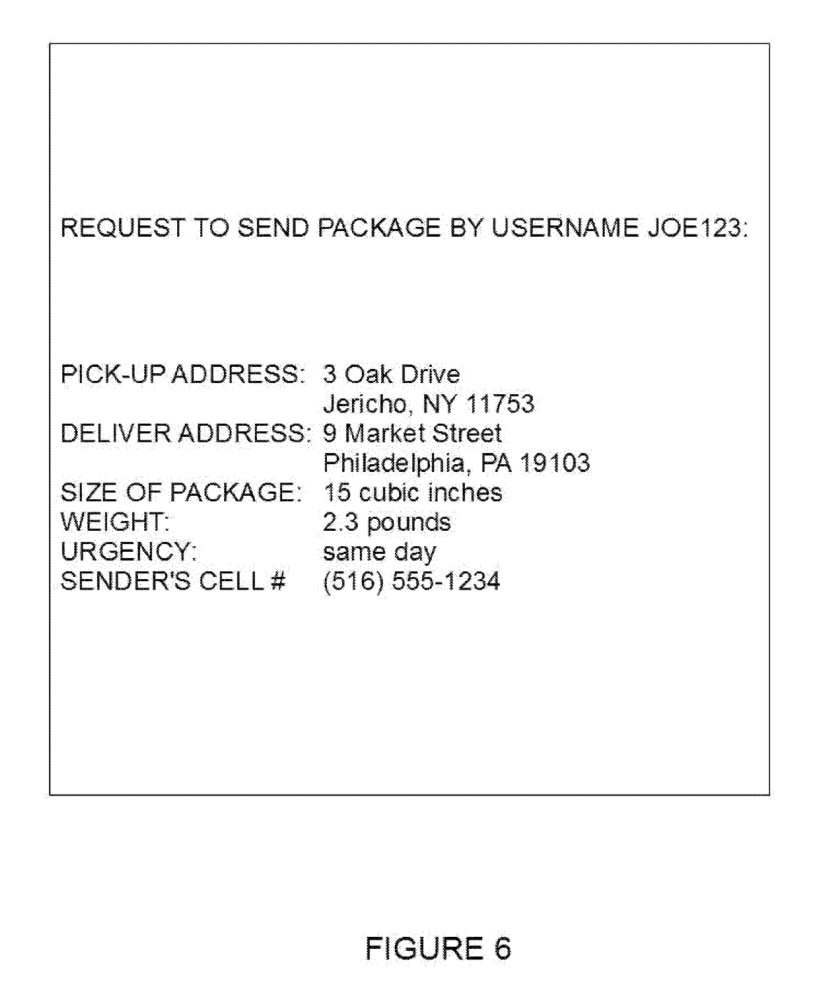

In operation 200, the sender (or manager or receiver) makes a request to the system (using a mobile device or web browser) for a package delivery (see FIG. 6). The sender would typically identify the pickup location (address), the destination location (address), size and weight of package, picture of the item, time-frame for the delivery (e.g., urgent rush, 24 hours, etc.), and any other relevant information about the delivery request.

From operation 200, the method proceeds to operation 201, which locates a potential deliverer. This can be done by starting with a set of all of the active participating drivers. The actual deliverer should be one which has the least amount of driving to do to reach the pickup (sender's) location and then driver to the drop-off (delivery) location and then (in some cases) the driver for the deliverer to return back where he/she started from. This can also consider each participating driver's current route. If a participating driver is heading in a particular direction, and the drop-off location is on (or near) the participating driver's current route, then there would be no return drive back to the participating driver's home (or other originating location) which would weigh favorably for selecting this particular participating driver. Distance computations can be performed for all of participating drivers so that the one with the shortest overall distance would be selected as the potential deliverer. Frequency of route computations can be performed for all of participating drivers so that the one with the most likelihood to already be traveling the requested route would be selected as the potential deliverer. More on this computation will be discussed below. Note that the potential deliverer also must meet other task criteria, e.g., he/she must have enough cargo space in their vehicle, etc.

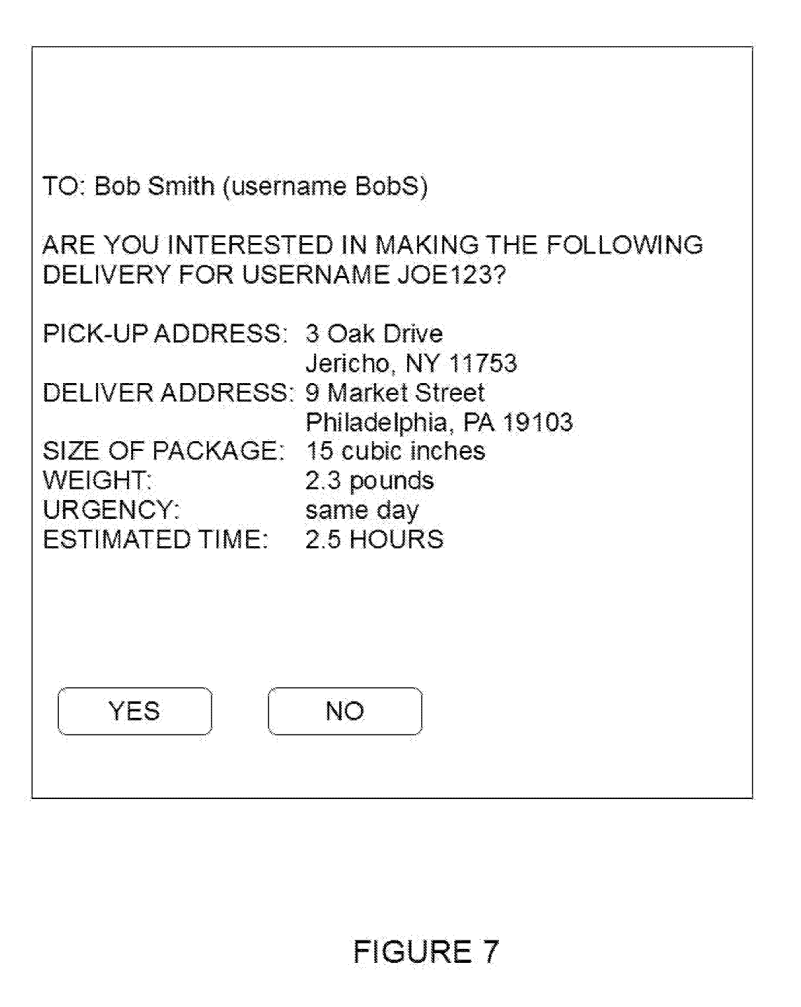

Once the best potential deliverer is selected in operation 201, then the method proceeds to operation 202, which prompts (see FIG. 7) that potential deliverer. The prompt can be done via text message, instant message, in-app notification, telephone call, etc., wherein the potential deliverer is asked whether he/she wishes to accept the particular task (package delivery).

From operation 202, the method proceeds to operation 203, wherein if this potential deliverer declines, then the method returns to operation 201, which will run the same algorithm again (but the potential deliverer that declined is removed from consideration for this task so that he/she will not be chosen again) and so the next best potential deliverer would be selected. One reason why a potential deliverer may decline is if he/she does not have enough free cargo space in their vehicle in order to accept the task. Of course, the potential deliverer may decline for any reason.

If in operation 203, the potential deliverer (the one prompted in operation 202) agrees to make the delivery, then the method proceeds to operation 204, which then proceeds to operation 204, which prompts the sender to confirm they approve of the potential deliverer delivering the sender's package. The sender would be presented with the identification of the potential deliverer (e.g., a picture, name, etc.) and the sender can confirm (by clicking a button) whether he accepts this potential deliverer (upon which the method proceeds to operation 206) or declines (upon which the method returns to operation 201 wherein another potential deliverer can be selected). In an embodiment, the deliverer's name and/or photo would only be displayed to the sender (also referred to herein as the sender) once the sender accepts the assignment of the potential deliverer. The sender (or other party arranging for the delivery) would always be able to see each potential deliverers' username, ratings, delivery history, etc.

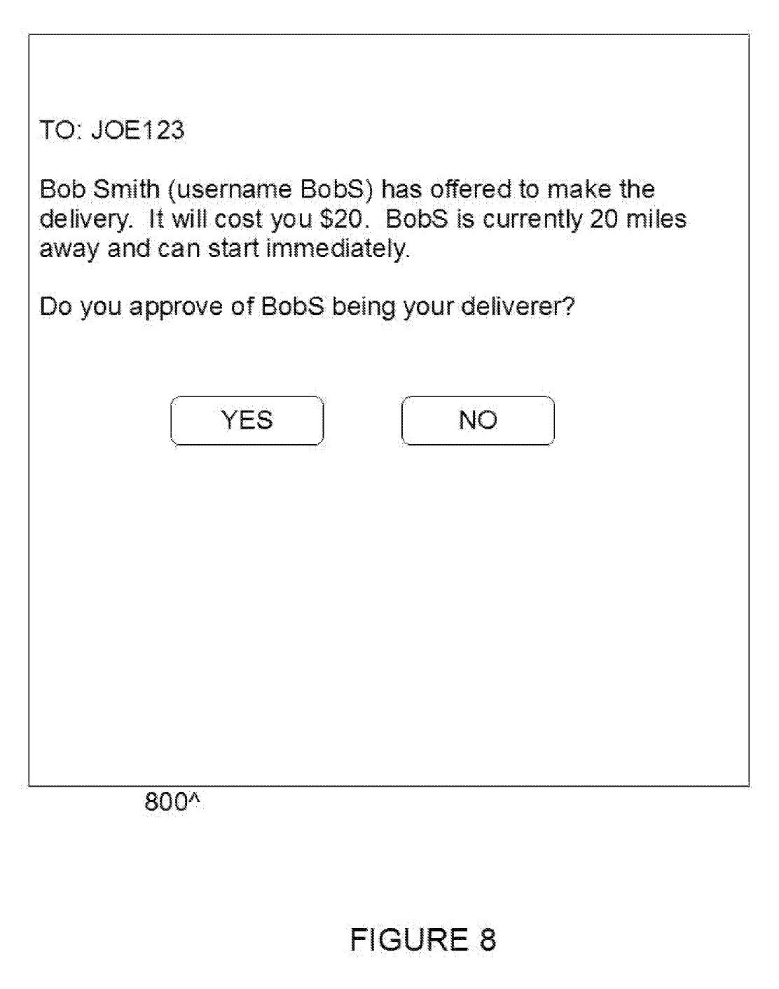

If the sender agrees in operation 205 to accept the potential deliverer (see FIG. 8), then the method proceeds to operation 206, which initiates delivery (starts operation 300). The potential deliverer is now the deliverer (and his/her status changes from “available” to “assigned a task”). Note that the sender has to pay for the delivery, although the receiver of the package or a manager who arranged the delivery can also be responsible for payment. A manager can be someone besides the sender, deliverer, and driver who is a person who has authority to arrange for delivers (and would arrange for payment of them as well). For example, a manager can be employed by a company who utilizes the delivery system described herein for the company's shipments and would make all arrangements for them to be delivered accordingly and make payment as well. A credit card (or other payment mechanism) can be associated with the manager (or sender or receiver) to easily pay for deliveries. Prices for deliveries can be computed based on a number of factors, such as number of miles (e.g., $0.10 per mile), and can optionally factor in additional factors such as weight (e.g., $0.10 per mile plus $1 per pound). The sender can pay now (upon initiation of the service) or upon completion of the delivery. The cost for the delivery can be determined based on a number of factors, such as the length of the delivery, the size or irregularity of size of the item being shipped, the urgency of the delivery (typically, the greater urgency (hence the quicker the delivery), the more expensive it would cost). The sender can pay using their mobile device and or web site, and can pay by any electronic payment mechanism (bank account transfer, SQUARE CASH, credit card, PAYPAL, etc.) The deliverer will be paid for the delivery, typically the amount that the sender pays with a percentage taken out (which is the commission kept by the company that administers the delivery system described herein).

Note that simultaneous delivery tasks can be performed by the same driver. A driver is not required to complete a delivery before initiating a new delivery task. Thus, a driver can have multiple (e.g., up to 10 or more) delivery tasks he/she is undergoing at the same time. The driver would typically be paid for each one individually (typically upon the completion of delivery for each delivery task). Thus, the driver carrying out multiple simultaneous delivery tasks would be paid at different times (upon each verified delivery).

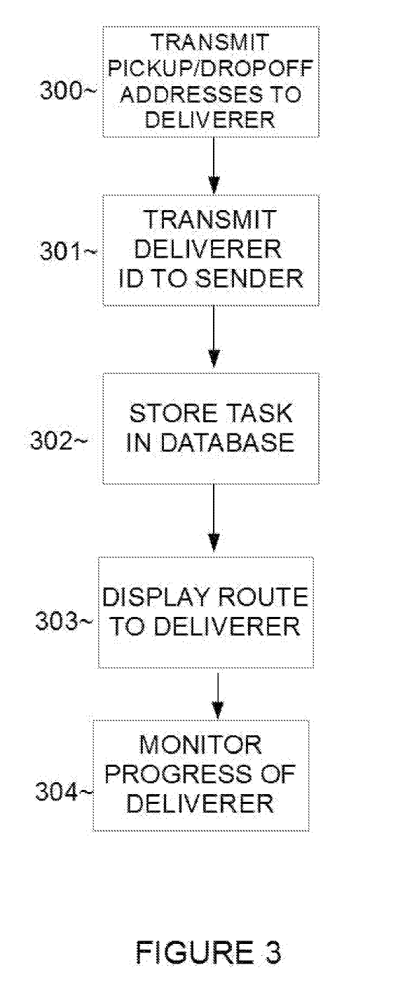

FIG. 3 is a flowchart illustrating an exemplary method of initiating a delivery of the package from the sender to the receiver, according to an embodiment.

In operation 300, the addresses of the pickup and drop-off (delivery) locations are transmitted to the deliverer. These may have already been transmitted in operation 202, but now the deliverer navigation system (which uses GPS or optimized geolocation tracking to tell the deliverer where to turn and how to find his/her way to the drop-off) receives these addresses so that the deliverer can easily navigate to the pick and drop-off locations (see operation 303). In one embodiment, an external navigation program can be used (e.g., MAPQUEST) would be controlled by the current system which would display turn by turn directions to the deliverer. In another embodiment, the software provided by the system (e.g., an app running on the deliverer's computing device) would provide the turn by turn directions.

From operation 300, the method proceeds to operation 301, which transmits the identification (e.g., the deliverer's username, etc.) of the deliverer to the sender. This may have already been done in operation 204, although now the sender can also view in real time the location of the deliverer on a map.

From operation 301, the method proceeds to operation 302, which stores the task (the details of the shipment which can comprise the identity of the sender, the identity of the deliverer, the pickup location, the drop-off location, the size of package, weight of package, picture of package etc.)

Note that even though the deliverer is now participating in a task, the deliverer is still a participating driver and may be available to pick up additional packages (after all, another task may have a pickup location on the deliverer's current route).

From operation 302, the method proceeds to operation 303, which displays the route to the deliverer on a map on the deliverer's computing device (e.g., smart phone, etc.) This serves as a navigation system for the deliverer.

From operation 303, the method proceeds to operation 304, which monitors the progress of the deliverer. The location of the deliverer is transmitted in real time to the system (stored in a database) so that the system knows where the deliverer is at all times. If the deliverer deviates from his/her given route (to the drop-off location) then an alert can be triggered which can be handled in numerous ways (a text message or a call to the deliverer on the deliverer's cell phone can be made, etc.) The real-time location of the deliverer will also be displayed (in a map or coordinates) to the manager, the sender and the receiver (the person to whom the drop-off is intended to be made).

The sender, receiver or manager can also call the deliverer (or vice-versa) by pressing a button the sender's screen which will call the deliverer's cell phone in case the sender wishes to contact the deliverer for any reason.

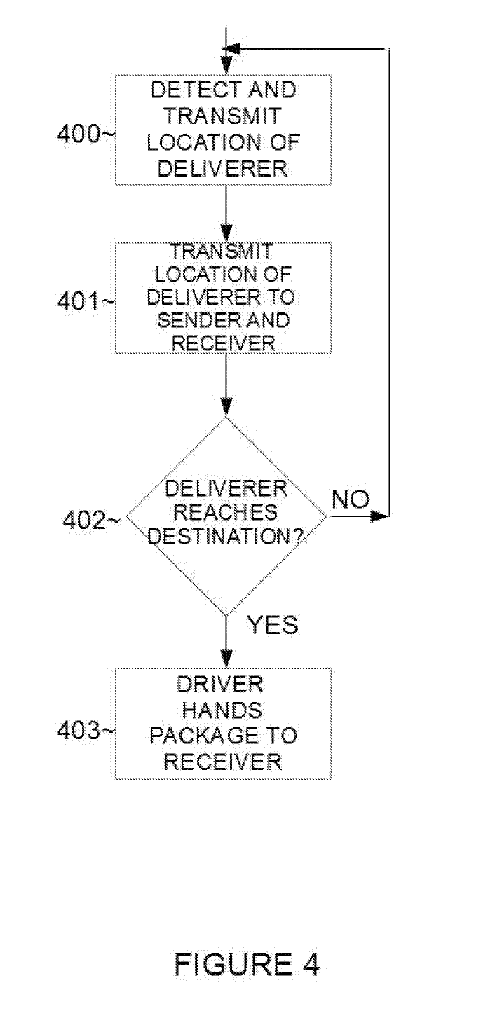

FIG. 4 is a flowchart illustrating an exemplary method of completing the delivery of the package from the sender to the receiver, according to an embodiment.

In operation, the location of the deliverer is detected. This can be accomplished by using any locator technology (or combination thereof), such as Wi-Fi, GPS, cell towers, etc. The location of the deliverer is transmitted to the server. Anywhere a location is determined herein, it can be done using any type of locator technology described herein.

From operation 400, the method proceeds to operation 401, which transmits (from the server) the location of the deliverer to the sender and/or the receiver and any other party involved in the transaction/task. This way both the sender (or manager) and the receiver can track their package and see where the deliverer is at all times during the delivery process.

From operation 401, the method proceeds to operation 402, which checks to see if the deliverer has reached the destination (drop-off location) where the receiver physically is. If not, then the method returns to operation 400, which continues the tracking process.

If in operation 402, the deliverer has reached the destination, then the method proceeds to operation 403, wherein the deliverer physically hands the package to the receiver. More on the actual process of handing off the package to the receiver will be discussed below in more detail.

Upon delivery (which can be verified/validated as described herein), then the deliverer can receive payment for the delivery. The payment would come from the server and would go into an account registered by the deliverer. The money for the delivery is added (from the server) to the driver's account. Typically, the fee for the delivery is the fee paid by the sender with a commission (fee) taken out by the server for arranging the delivery. The deliverer can withdraw funds from his/her account in numerous ways, such as PAYPAL, can request (and receive) a bank check in the mail, and receive an electronic funds transfer into the deliverer's bank account, etc.

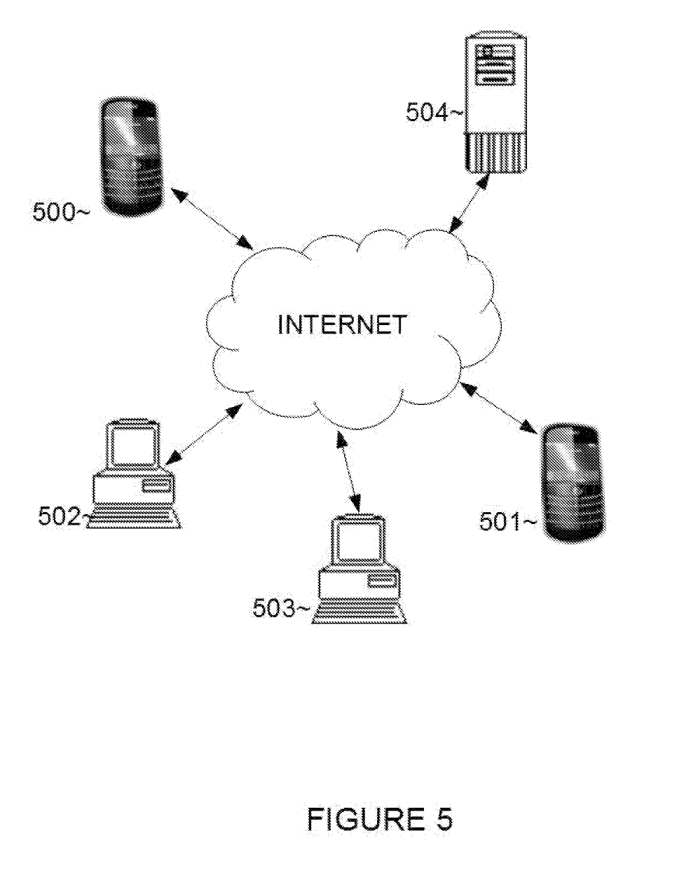

FIG. 5 is a block diagram illustrating participants of the system on a computer communications network, according to an embodiment.

Drivers 500, 501 can communicate with a server 504 (also referred to herein as the system) using their mobile phones (or other portable computing devices such as laptops, etc.) The server 504 communicates with all of the participants of the system and directs all features herein Senders 502,503 use their computers, mobile phones, etc. to communicate with the server 504 (senders can also use mobile phones as well). All information herein can be transmitted by any party described herein and received by any party described herein including the server 504. It can be appreciated that any number of users (e.g., drivers, senders, receivers, managers, etc.) can utilize the system simultaneously even though all such parties are typically in different physical locations throughout the country. For example, there can be 10, over 10, 10-100, over 100, 1000, over 1000, or any number (from 1 to a million or more) of simultaneous users (with any number of drivers, senders, receivers, managers, etc.) of the system which are all processed virtually simultaneously. For example, there can be 1-100 or more drivers being location tracked at one time and the server 504 will process the tracking of all such drivers simultaneously even though they are located all over the country.

FIG. 6 is an example of a dialogue box which illustrates a request for a delivery task made by a sender, according to an embodiment.

In operation 200, a sender enters a request for a delivery to be made from a pick-up address (typically the sender's address although this is not required) and a destination address. Also included in the request is information about the package to be delivered, such as the dimensions and weight of the package. A dialogue box such as that illustrated in FIG. 6 can be used, where the sender types in all of the answers to each of the fields. Note that this is just one example, and any other fields can be used as well. Note that the sender can also take a picture of the package with the sender's sell phone and upload it so that potential deliverers can see the size of the package. A category field can also be inputted from the sender (and displayed to the potential delivers). Categories can comprise electronics, perishables, etc. All known information about a package would be displayed to potential deliverers.

FIG. 7 is an example of a dialogue box which illustrates a request to a potential deliverer to make a delivery, according to an embodiment. In one embodiment, potential deliverers can search for delivery tasks, and in another embodiment delivery tasks can be automatically suggested to users.

Alerts can be presented to potential drivers asking them if they want to make a particular delivery. The dialogue box in FIG. 7 illustrates how the information on the delivery can be presented to the potential deliverer. This can include the estimated time it would take the potential deliverer to deliver the package taking into consideration the potential deliverer's current location which can be determined via GPS or cellular triangulation on the potential deliverer's mobile phone (or other technology).

FIG. 8 is an example of a dialogue box which illustrates a confirmation query so the sender can approve the selection of the potential deliverer, according to an embodiment.

The sender is presented (operation 205) with the identity of the potential deliverer so that the sender can then approve or decline this particular potential deliverer. If the sender does not approve of this particular deliverer, then the system can find another potential deliverer (return to operation 201). In one embodiment, for privacy reasons the information about a potential deliverer presented to the sender (or other party who is arranging for shipment of the package such as a manager or sender) is limited (such as only displaying a username, location, reviews from other users of the system, etc.) In another embodiment, all details about a potential deliverer can be presented to the sender (including the potential deliverer's real name, photo, reviews by other users who have used this particular deliverer, average rating, etc.). Each receiver who receives a package delivered by the deliverer can write a review and also give a star rating (e.g., out of four stars with four being the best) and all of a deliverer's star ratings can be averaged and displayed to other users of the system such as future senders they can utilize this information when making their choice of driver. Note that driver and deliverer are used synonymously herein.

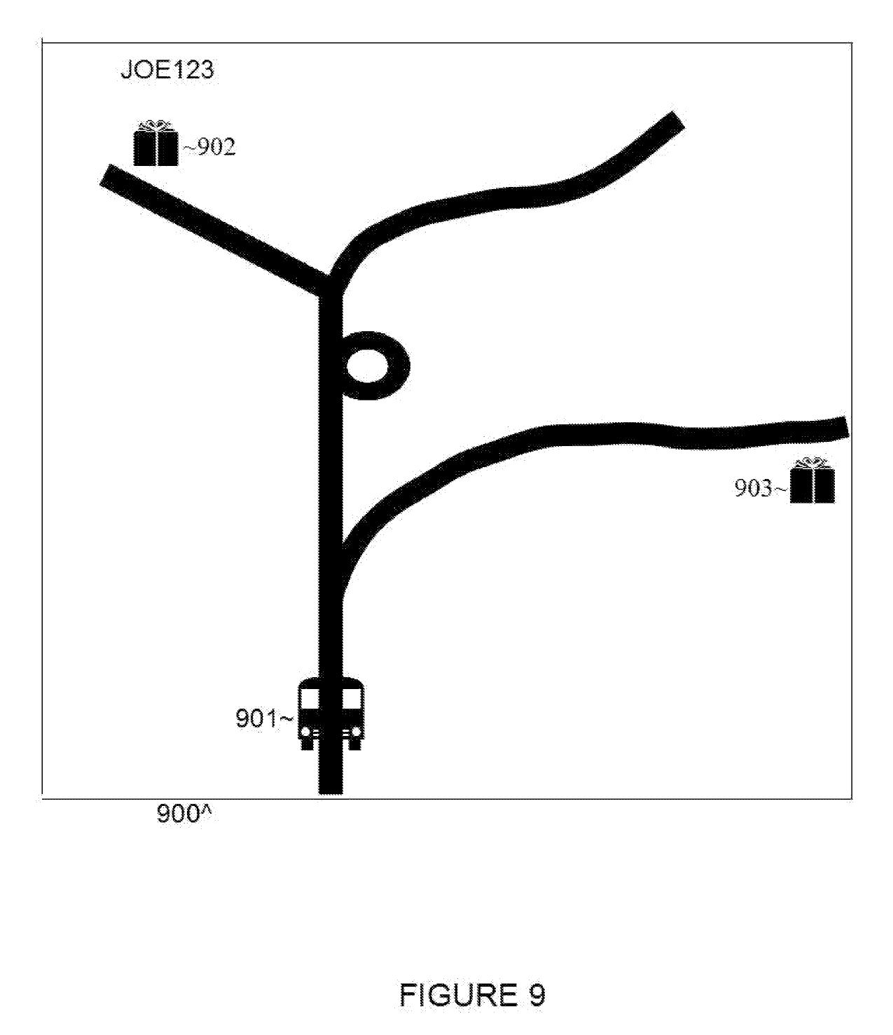

FIG. 9 is a sample heads up map display that can be displayed on a driver's output device, according to an embodiment. Note that upon a user (e.g., driver/deliverer, manager, sender) registering (creating an account), the user can identify which navigation application they prefer which would be invoked as needed to display turn by turn navigations as described herein. In another embodiment, an external navigation application would not be needed as the system herein would have its own navigation application that would be downloaded and run on deliverer's computing devices which would have all of the functionality described herein. The map can also display points of interests (such as partner businesses which offer discounts to drivers such as restaurants, hotels, etc.)

A real time map 900 can be displayed on the deliverer's output device (e.g., the deliverer's GPS device, cellular phone, etc.) The map 900 can display the deliverer's current vehicle 901, the surrounding roads, weather, construction, and traffic information, and any other delivery tasks 902, 903 nearby that currently need a deliverer. If the deliverer is interesting in learning more about the other delivery tasks 902, 903 and the deliverer can touch such delivery tasks 902, 902 which would bring up a window similar to FIG. 7 but with the data for each respective task. In an embodiment, instead of touching the map, tasks can be presented to the driver/deliverer in the form of pop-up or text messages. Note that on the map partner businesses can be displayed as well. A partner business is a business that has a relationship with the operators of the system described herein so that they agree to provide discounts on goods and services they provide to users of the system. For example, any user may see a particular gas station on the map which offers gas at a discount to users (of the system described herein) as opposed to a standard price offered to the general public. Partner businesses can be hotels, restaurants, or any type of establishment.

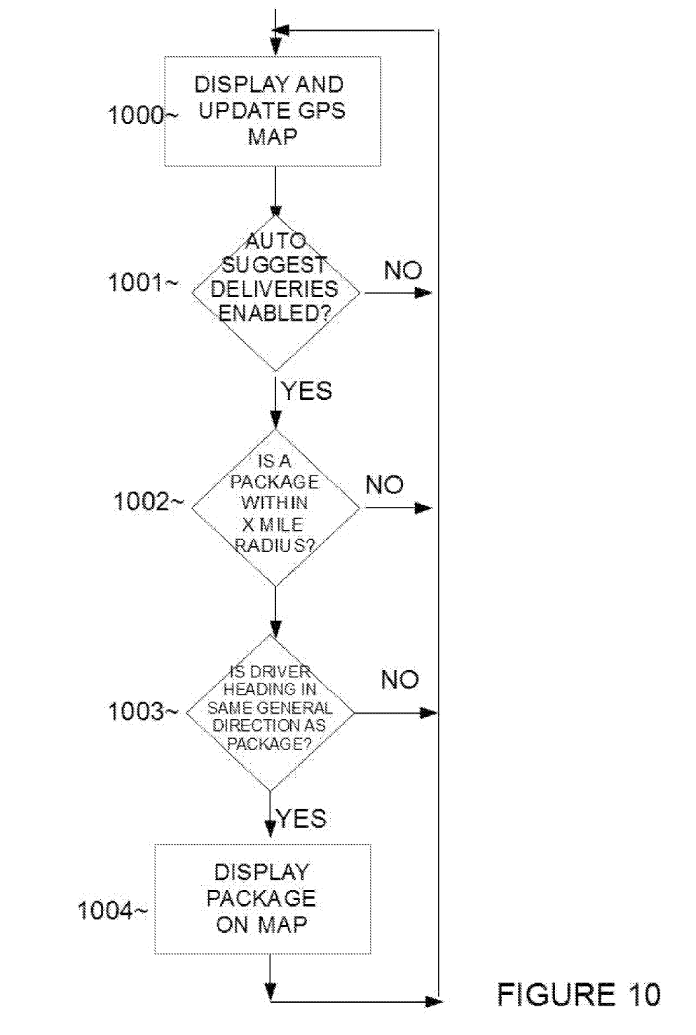

FIG. 10 is an exemplary flowchart illustrating an updating of the driver's output display, according to an embodiment.

The method can begin with operation 1000, which displays and updates a map to a driver (see FIG. 9), also referred to as navigation map, which provides directions to the driver based on the driver's current physical location. The map is based on the driver's current location (determined by GPS or any other mechanism) with the driver's current location being displayed on the map. The driver can be a deliverer or any driver that is part of the system. The map is updated in real time (e.g., as the driver moves physical location, the map adjusts accordingly). If the driver is a deliverer with a pickup (or drop-off) point to reach, the map will highlight the roads the deliverer needs to take in order to reach the respective destination or provide turn by turn directions.

From operation 1000, the method proceeds to operation 1001, which determines whether the driver has enabled auto suggest of potential deliveries. The driver can set a setting where the output device would automatically display nearby package delivery tasks (or not only the map but other package delivery tasks can be pushed to the driver's phone or other computing device).

If this setting is turned off, then the method can return to operation 1000.

If the setting is enabled in operation 1001, then the method proceeds to operation 1002, which determines whether there is package (a delivery task with a pickup location) is in a X mile radius (wherein X is a predetermined threshold such as 5 miles, etc.) Note that the package (task) must not yet have a deliverer (if it does, there is no point showing it on drivers' maps). If no such package with a pickup location is nearby (within X miles), then the method returns to operation 1000.

If in operation 1002, there is a package with a pickup location within the X mile radius, then the method proceeds to operation 1003, which determines whether the driver is heading in the same general direction as (or the predicted route the driver is pursuing will pass near) where the package pickup location is located. If not, then the method returns to operation 1000.

If the driver is heading in the same general direction as the where the package pick up point is located (e.g., the driver does not have to go out of his way by more than Y (predetermined threshold) miles or Z (predetermined threshold) estimated minutes, then the method proceeds to operation 1004, which alerts the driver (push notification, in app message) of a potential job (task) or by displaying the package task on the driver's map (see FIG. 9, tasks 902, 903). In this way, as a driver (or deliverer) is driving, delivery tasks can automatically appear on the driver's electronic output display which may be on route (or not that much of a deviation) such that the driver would not go too much out of his way to pick up those package(s). Once a package task is displayed on the map, then the user can touch (or select using any other selection method such as buttons, mouse, voice commands, etc.) those tasks to learn more information about them (see FIG. 6). If a task is presented to the driver in a pop-up message (or instant message, etc.) then the driver can learn the same information about the task by pressing buttons inside (or alongside) the message.

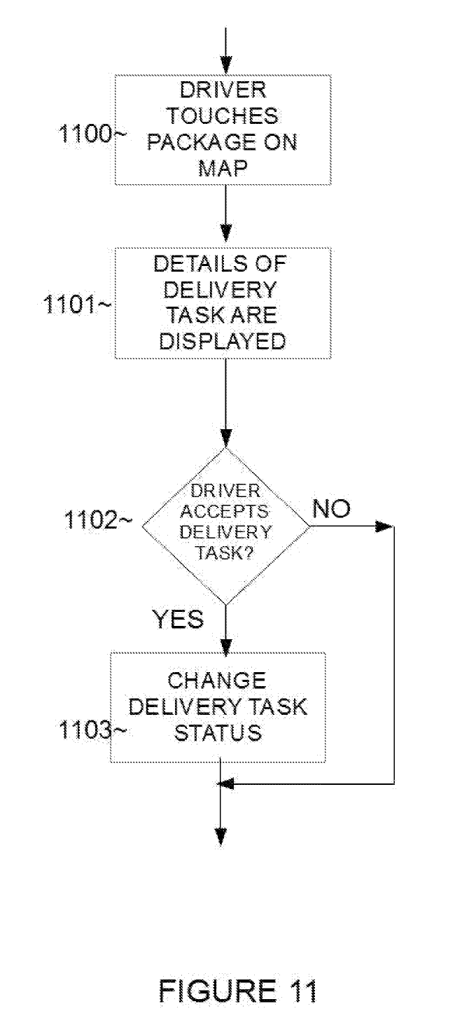

FIG. 11 is an exemplary flowchart illustrating an acceptance of a delivery task, according to an embodiment.

A driver is interested in taking on a new task displayed on the driver's output device. So the driver touches (or selects using another selection method) a package on the output device.

From operation 1100, the method proceeds to operation 1101, which displays details of the delivery (or package) task on the output device (e.g., pickup location, delivery location, size of package, etc.).

From operation 1101, the method proceeds to operation 1102, which determines whether the driver accepts the delivery task. The driver can accept or reject the delivery task by pressing buttons on the driver's device. If the driver does not accept the delivery task, then nothing changes.

If in operation 1102, the driver accepts the delivery task, then the method proceeds to operation 1103, which changes the delivery task status. Each delivery task has a status which can be in a set comprising (deliverer needed, deliverer assigned, delivery in progress, delivery complete). If the driver accepts the delivery task, then the status of the delivery task would change from deliverer needed to deliverer assigned. Newly requested delivery tasks by senders would have the status deliverer needed. Once a deliverer is found, then the status of the delivery task would change from deliverer needed to deliverer found (also referred to as deliverer assigned). Two other statuses of the delivery task can be delivery in progress and delivery complete. Each delivery task would have one of these four statuses. Delivery tasks which the status of deliverer found would no longer appear on other driver's maps (heads up displays) because a deliverer for that delivery task is no longer being sought.

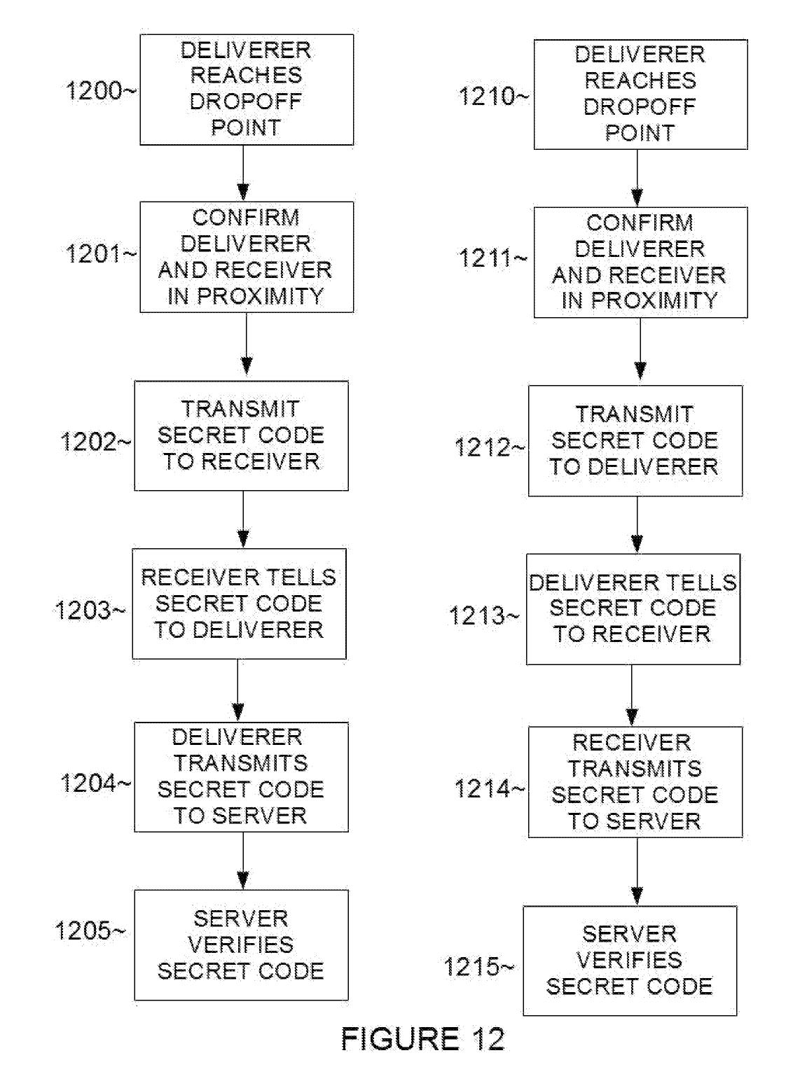

FIG. 12 is a flowchart illustrating an exemplary method of verifying a delivery, according to an embodiment. When a task has been double accepted (both the deliverer accepts and the sender (or who arranged for the deliver) accepts the assignment of the deliverer), the receiver will receive a code either via email or SMS. When the package is delivered the receiver and/or the deliverer will be located and prompted for the code to be entered on their mobile phone.

In operation 1200, the deliverer physically reaches the drop off location. This can be done as described herein (e.g., following the directions on the deliverer's GPS/navigation device which can be the deliverer's cell phone or other computing device). The deliverer can then press a button on his cell phone (or other device) to initiate the verification process (for any of the delivery verification methods).

From operation 1200, the method proceeds to operation 1201, wherein the system located but the driver and the receiver and confirms that the deliverer and receiver are in proximity. In other words, the physical distance between the deliverer and the receiver is smaller than a predetermined threshold (e.g., 10 feet or other distance). The location of the deliverer and the receiver can be ascertained by using locating technology (such as GPS, Wi-Fi-locating, cell towers, etc.) using the deliverer's and the receiver's cell phone. If the deliverer and the receiver are not in proximity to each other, then the method would not proceed to operation 1202.

If and when the sender and the deliverer are in proximity to each other, then the method proceeds to operation 1202, which transmits a secret code to the receiver (in another embodiment the secret code would have already been transmitted to the receiver when the task was initiated in operation 206). The secret code is a non-public code (which could have been generated randomly) which the deliverer would have no way of knowing. The secret code can be transmitted to the receiver via an email, text message, voice call, web site URL, etc.

From operation 1202, the method proceeds to operation 1203, wherein the receiver tells (speaks) the secret code to the deliverer.

From operation 1203, the method proceeds to operation 1204, wherein the deliverer transmits the secret code received from the receiver (in operation 1203) to the server. For example, the deliverer can type in the secret code received from the receiver into the deliverer's cell phone, which then transmits the code to the server (using an app or web functionality). The receiver could also be required to type the code into the deliverer's phone (instead of the deliverer typing it in which means operation 1203 does not have to be performed). The receiver may also be required to sign for the package on the delivers mobile device (using a stylus or their finger on the output device) to confirm the delivery, the signature will be transmitted to the server.

From operation 1204, the method proceeds to operation 1205, wherein the server verifies that the secret code transmitted by the deliverer (in operation 1204) is the same secret code that was transmitted to the receiver in operation 1202. If the secret code (or “code”) is not the same (or for some other reason the method does not reach this operation) then the delivery is not verified (this can be handled in numerous ways, for example nothing can happen, or an alert can be triggered in which the system would inquire what has happened which can entail a call to the receiver and/or deliverer).

If the secret code is verified (the code sent to the receiver matches the code sent by the deliverer) then the delivery is validated. This means that the system has confirmed that the package has indeed been delivered to the receiver. The validated status is reflected on the deliverer's profile and the deliverer (driver) is also now paid for the completed delivery.

Operations 1210-1215 illustrate an alternative embodiment. Operations 1210, 1211, 1212, 1213, 1214, and 1215 are the same to their counterparts (1200, 1201, 1202, 1203, 1204, and 1205) except for the roles of receiver and the deliverer are reversed. In other words, in operations 1210-1215, the secret code is transmitted to the deliverer (not the receiver as in operation 1202) and is told to the receiver (instead of the deliverer in operation 1203) so that the receiver (instead of the deliverer in operation 1204) transmits the secret code to the server (in operation 1214) so that the server can verify the secret code.

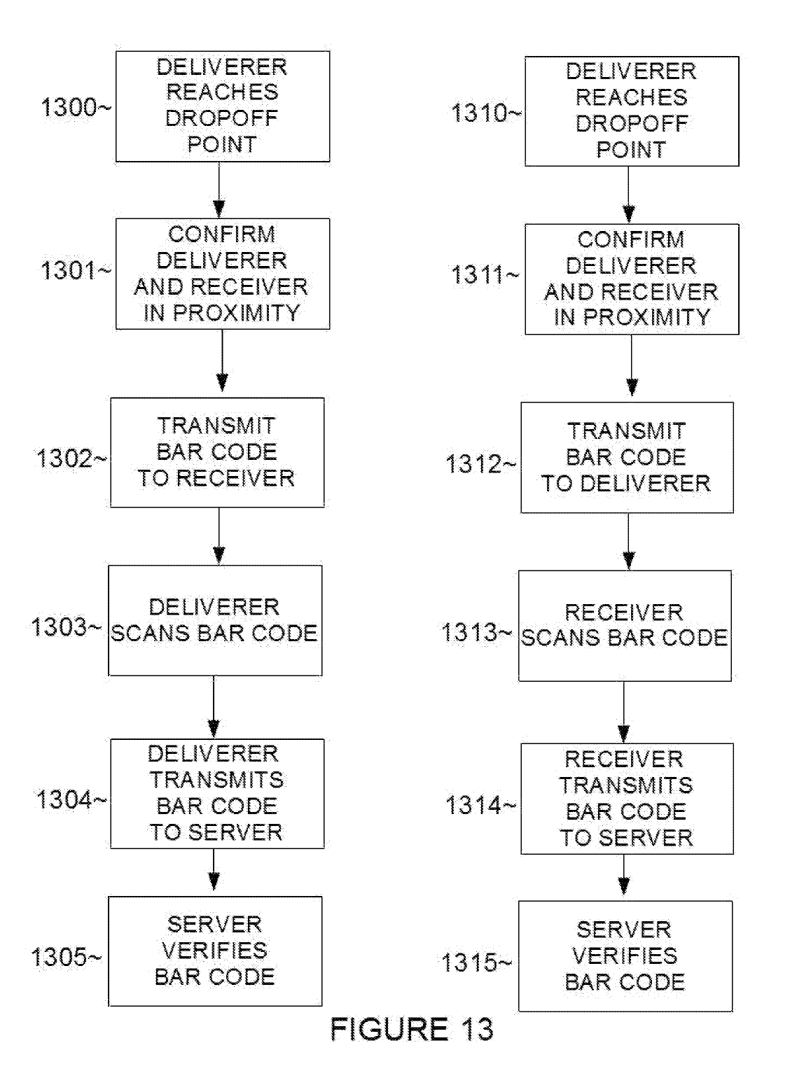

FIG. 13 is a flowchart illustrating an exemplary method of verifying a delivery using a bar code, according to an embodiment. The method illustrated in FIG. 13 is similar to that illustrated in FIG. 12 but uses a scannable bar code or quick response (QR) code instead of a secret code. This saves the deliverer or the receiver having to type in the secret code into their computing device.

Operations 1300 to 1301 are performed identically to operations 1200 to 1201.

In operation 1302, a bar code, quick response code, or other image is transmitted to the receiver's computing device (e.g., cell phone, tablet, portable computing device, personal computer, etc.) The receiver's computing device would then display this code (e.g., using an app, web page, text message etc.)

From operation 1302, the method proceeds to operation 1303, wherein the deliverer then scans (e.g., takes a picture of) the bar code being displayed on the receiver's computing device (which the receiver makes available to the deliverer).

From operation 1303, the method proceeds to operation 1304, wherein the deliverer transmits the bar code or quick response code (either the actual optical image or a decode of the image such as its respective text string) to the server.

From operation 1304 the method proceeds to operation 1305, wherein the server verifies the bar code. This is done by comparing the bar code received by the server (in operation 1304) with the bar code transmitted to the receiver (in operation 1302). If there is not a match, then the verification fails (the package is not confirmed being delivered). If there is a match (both bar codes are the same), then the delivery is verified. The verification status is stored in the server (so in case there is a problem of a missing package, it can be retrieved from the server that the package was indeed delivered).

Operations 1310 to 1315 are identical to operations 1300 to 1305 but the bar code is transmitted to the deliverer (operation 1312) instead of the receiver (operation 1302), scanned by the receiver (operation 1313) instead of the deliverer (operation 1303) and the receiver transmits the bar code to the server (operation 1314) instead of the deliverer transmitting the bar code to the server (operation 1304). Operations 1310, 1311 and 1315 are performed identically to operations 1300, 1301, 1305.

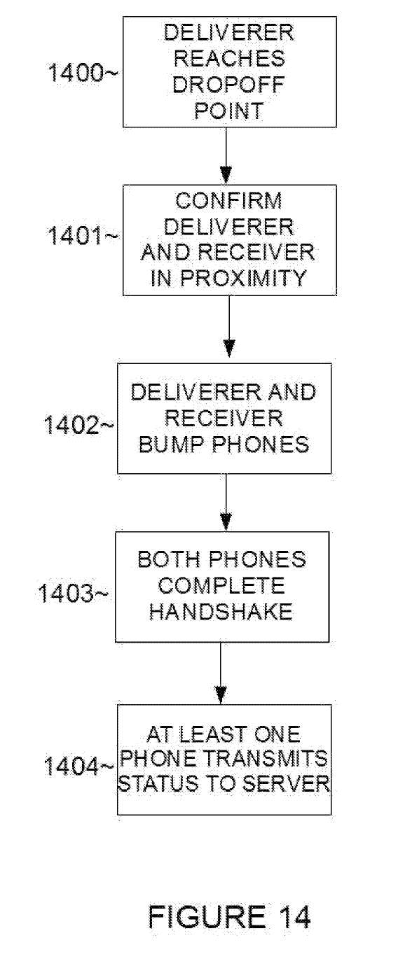

FIG. 14 is a flowchart illustrating an exemplary method of verifying a delivery using near field communication, according to an embodiment. As an alternative to having to type in a secret code or scan a bar code, the receiver and deliverer can “bump” (hold close together) their cell phones (or other portable computing devices) and the phones can communicate with each other in order to effectuate the verification process.

The method can begin with operation 1400, wherein the deliverer reaches the drop-off (delivery) point. This is done as described herein.

From operation 1400, the method proceeds to operation 1401, which confirms that the deliverer and receiver are in proximity. This is done as described herein (for example, see operation 1201).

From operation 1401, the method proceeds to operation 1402, wherein the deliverer and the receiver bump phones. This means the phones are brought close together (e.g., with a few inches) and software (e.g., apps) running on each phone are configured to effectuate a wireless handshake between both phones (and other portable devices) using Bluetooth (or other wireless technology).

In operation 1403, the phones (or other computing devices) complete the handshake. For example, the deliverer's mobile device (e.g., portable computing device, etc.) can send a wireless signal (which can be a wireless code sent to the deliverer by the server) which is received by the receiver and transmitted (operation 1404) (by the receiver) to the server to confirm the wireless code is authentic. Or this process can work in reverse (the receiver's mobile device can send a wireless signal (which can be a wireless code sent to the receiver by the server) which is received by the deliverer and transmitted (operation 1404) (by the deliverer) to the server to confirm the wireless code is authentic. The server records that the delivery has taken place (verifies delivery).

If the receiver does not have a smart phone (or other computing device) capable of effectuating any of the verification methods illustrated in FIGS. 12-14, then another verification method can be used, such as using email or a text message to transmit the code to the receiver. Typically, the driver would have a smart phone capable of implementing all of the methods described herein.

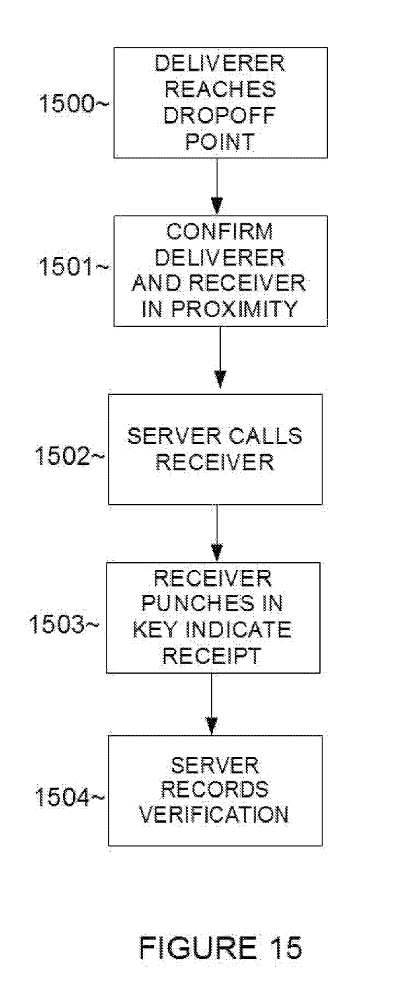

FIG. 15 illustrates a delivery verification method that does not require a smart-phone, according to an embodiment. The method illustrated in FIG. 15 would require a phone.

Operations 1500 and 1501 can be performed as operations 1200 and 1201.

The deliverer would push a button on his phone to indicate completion of the delivery. In operation 1502, an automated call can be made to the receiver (from the server) asking the receiver to push a key on the receiver's phone. For example, the receiver is instructed to press ‘1’ if they have received the package and ‘2’ if they did not receive the package.

From operation 1502, the method proceeds to operation 1502, wherein the receiver actually pushes the respective key in their phone (can be land line or mobile phone).

In operation 1504, a result of this transaction is recorded at the server. If the key pressed by the receiver in operation 1503 indicates a successful delivery (e.g., ‘1’) then the server records that the package was delivered successfully. If the key pressed by the received in operation 1503 indicates that the package was not received (or no key at all is pressed), then the server would record that the package was not delivered successfully (and appropriate action can be taken, such as launching an investigation to track down the package).

Note that when the deliverer delivers the package to the receiver (e.g., the deliverer reaches the drop-off point), another verification technique that can be implemented is that pictures can be taken and transmitted to the server. For example, the deliverer can take a picture of both the package and the receiver which confirms that the receiver received the picture. In another embodiment, the receiver can take a picture of the package and the deliverer which also serves as confirmation of the delivery. The receiver and/or deliverer can also take a picture (photo) or pictures of the package itself (and optionally the inside as well) to confirm that it arrived intact. In another embodiment, a picture can be taken of the deliverer, the receiver, and the package (all in the same picture). All of these photos can be taken by the receiver's or the deliverer's portable computing device (e.g., smart phone) which also would have a camera. The pictures taken and transmitted to the server (which are stored for later retrieval) can also be tagged with a time the picture was taken and the location where it was taken (determined by the computing device used to take the photo using its GPS device, etc.) so it is documented where physically the picture was taken. The system can be configured to not allow such pictures, require such pictures, or make such pictures optional. If required for verification, the particular type of picture (e.g., the package with the receiver taken by the deliverer) would be specified so it can be complied with. If system is configured to require such a photo for verification, then the delivery would not be consider verified until such picture was received by the server (and optionally confirmed by the server that it is acceptable). Or alternatively, such a photo can be required by the system but not used for verification (so in case if a dispute about damage to the package, the photo can be retrieved to determine the condition of the package upon delivery).

As a driver is driving but not in the role of deliverer (he/she is going about their regular life), predictive modeling can be used to predict where the driver is going and then based on the predicted destination, automatically suggest delivery tasks which may be consistent with the driver's destination. For example, if the driver drives to a first location each morning, it can be predicted that the first location is the driver's job location. Thus, while the driver is on his/her way to the job location each morning, delivery tasks (if any) can be identified and prompted (the driver is given the opportunity to review and accept the delivery task(s)) which are compatible with the driver's current predicted route. Compatible meaning that the distance for the driver to reach the pick-up location and then reach the drop-off location and then reach the original destination (the driver's job location) minus the distance the driver has to reach the driver's job location (the current route) is lower than a predetermined threshold. In other words, a compatible delivery task would be one which would not take the driver too much out of his/her way.

As another example, a driver periodically (e.g., once a month) makes a 100 mile drive from the driver's house to a particular location. The particular location can be the driver's friends' house, but the system has no way of knowing that, the system knows that with a frequency of approximately once per month, the driver drives to this particular location. So when the driver is on a route which is heading to this particular location (and no other previously visited locations by this driver have been on this route), then the system can predict that the driver is headed to the particular location. The system can then check for any delivery tasks which are compatible with the predicted route that the driver is taking. For example, if the distance for the driver the particular location is 85 miles, and the distance from the current driver's location to a pickup location to a drop-off location and then to the particular location is 110 miles, then the driver only has to drive an additional 25 miles to complete this delivery task. Thus, the additional mileage the driver has to drive is lower than a predetermined threshold (which can be any number, e.g., 50) so this delivery task will be prompted to the driver. So if the additional mileage the driver has to drive to complete a delivery task is lower than the predetermined threshold then the delivery task will be prompted to the driver, but if the additional mileage the driver has to drive to complete the delivery task is not lower than the predetermined threshold then the delivery task would not be prompted to the driver.

The threshold can also be a percentage of the current trip's mileage. For example, the additional mileage to undertake the delivery task is 25 miles and 25/85 is 0.29 (or 29%), and thus the driver only has to increase his mileage by 29% in order to complete this delivery task. Thus, delivery tasks can be prompted to the driver which have an additional mileage percentage lower than a relative threshold (e.g., 30%), whereas delivery tasks with additional mileage percentage not lower than the relative threshold would not be prompted to the driver.

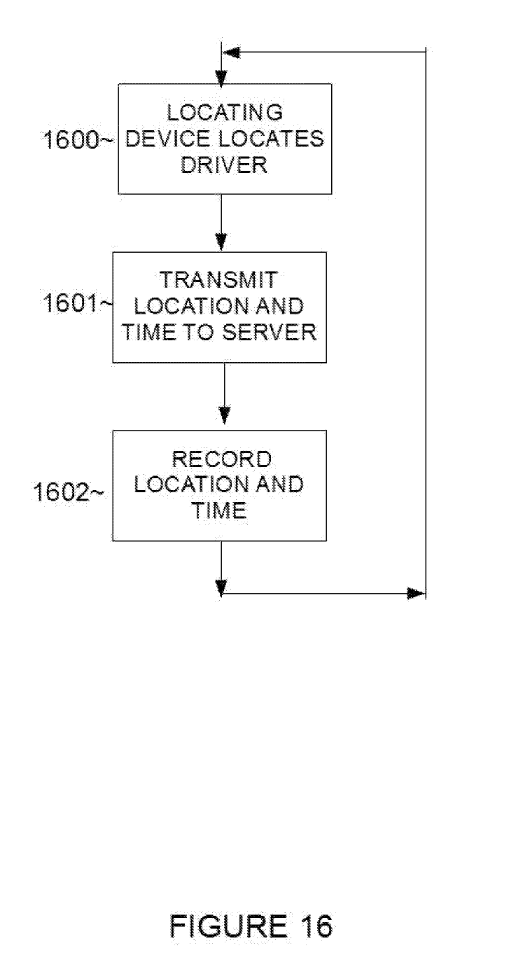

FIG. 16 is a flowchart illustrating an exemplary method of tracking and recording driver locations, according to an embodiment. The system can continuously monitor each driver's location (assuming they give permission for this type of tracking) and store their locations (locally on the driver's phone and/or on the server). Thus, FIG. 16 can be performed for each driver.

The method can begin with operation 1600, which locates the driver. This can be done using any location technology, such as GPS, Wi-Fi, cellular towers, etc., or any such combination which locates the portable computing device/mobile phone associated with the driver. Upon registration, each driver would identify his/her portable computing device/mobile phone so it can be tracked (e.g., by sim card number, cell number, etc.)

From operation 1600, the method proceeds to operation 1601, which transmits the location and time of the driver from the driver's mobile phone (or other portable device the driver has with him/her) to the server. This is only performed in the embodiment where the server would store this location information.

From operation 1601, the method proceeds to operation 1602, which records the location and time (on the driver's portable device and/or the server). The data is typically recorded on non-volatile storage and associated with the driver's account on the server so that the location and time data can be easily retrieved when analyzing each driver's respective location and time data in real time.

When a driver has location and time data accumulated, this data can be used to generate a destination list of destinations the driver has visited. The destination list can then be used to predict the route used by the driver.

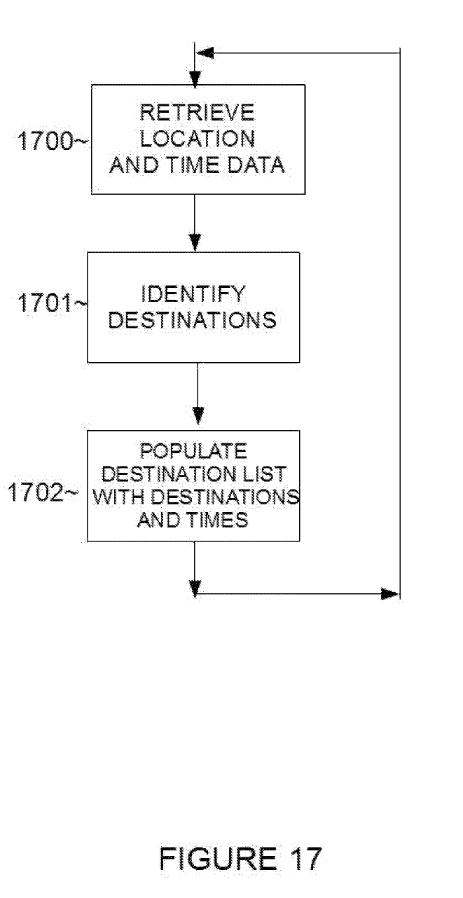

FIG. 17 is a flowchart illustrating an exemplary method of populating a destination list, according to an embodiment. Operation 17 can be run at any time once location and time data has been accumulated. It can be run periodically (e.g., each day, week, etc.) to process the additional time and location data that has been accumulated during that period.

In operation 1700, the computer implementing the method (the portable computing device used by the driver and/or the server) retrieves the location and time data.

From operation 1700, the method proceeds to operation 1701 which identifies destinations visited by this driver. Destinations can be identified by the location of the driver not changing (by more than a small amount such as when the driver is walking with the device) for at least a predetermined period of time. For example, if the driver is at a particular location for more than the predetermined period of time (e.g., 2 minutes), then it is concluded that this particular location is a destination where the driver got out of his vehicle. The driver can move at the particular location by a small amount (e.g., less than a predetermined location distance such as 100 feet) but if the driver does not move more than this distance (measured from the point the destination as identified) then it is assumed the driver is not in a vehicle. At some point the driver will move more than the predetermined location distance and it is assumed that at this point the driver has started to drive away.

From operation 1701, the method proceeds to operation 1702, which populates a list with all of the destinations from operation 1701 and the respective dates and times that destination was visited. This list is stored (and aggregated with any prior such lists for this driver) so it can be accessed at any time. Note that in an embodiment, this list would not be displayed to the driver (or anyone else), although in another embodiment the driver would be allowed to view the list. A destination list such as that in Table I can be generated.

TABLE I

| | | | | | fre- |
|---|---|---|---|---|---|
| # | address | date | time | route taken | quency |
| 1 | 534 Pine Street, | 1/4/13 | 08:43 | Routes 401, 407 | 2 |
| | Atlanta | | | | |
| 2 | 5 Oak Street, | 1/4/13 | 22:10 | Candler St | 1 |
| | Atlanta | | | | |
| 3 | 10 Galleria Place, | 1/7/13 | 07:12 | routes 2, 13 | 12 |
| | Marietta | | | | |
| 4 | 534 Pine Street, | 1/8/13 | 08:41 | Routes 401, 407 | 2 |
| | Atlanta | | | | |
| . | | | | | |
| . | | | | | |
| . | | | | | |

Note that the list has a frequency column which is the number of times that the driver visited this particular location. Note that the list is incomplete as more entries exist (e.g., 11 more visits to #3) and is just shown as an example of the data that can be populated in the list. The route taken shows the route that the driver took when reaching the destination. This can be used to aid in the prediction of a driver's destination (if the driver is on a particular route heading in a direction that matches one of the addresses in the list and the driver is on the same route, then it can be used to predict that the driver is headed towards that address).

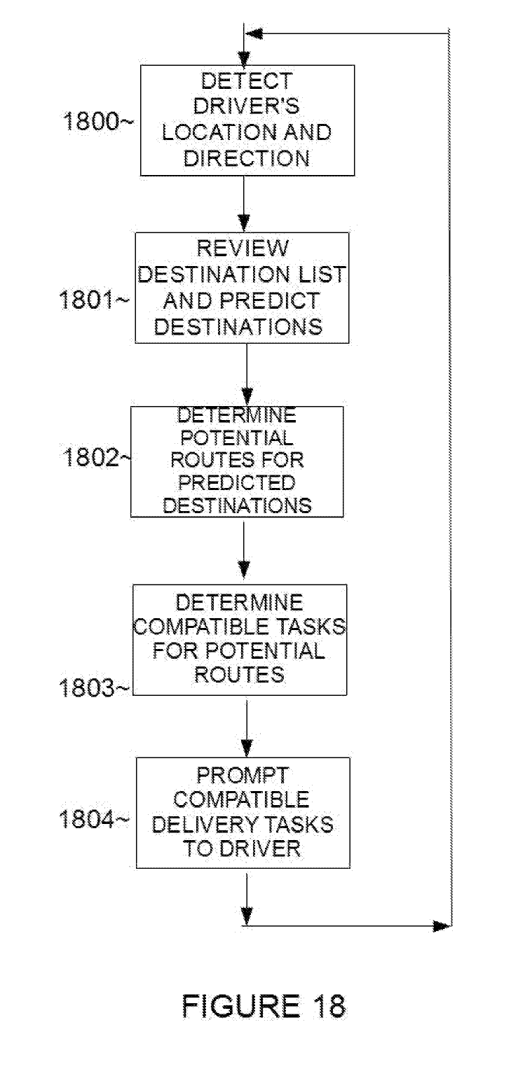

FIG. 18 is a flowchart illustrating an exemplary method of identifying compatible delivery tasks based on predictive routes, according to an embodiment. Compatible delivery tasks are prompted to the driver so the driver can accept the tasks if he/she chooses. The method illustrated in FIG. 18 would be constantly running (assuming the driver has granted permission) so even when the driver isn't performing a delivery task, the driver can be prompted with compatible delivery tasks.

In operation 1800, the driver's location and direction are detected. This can be done as described herein, using locating techniques (GPS or cellular triangulation, Wi-Fi, cell towers) and over time, the direction can be determined from a vector formed by the locations.

From operation 1800, the method proceeds to operation, which reviews the destination list (for this particular driver of course) and determines predicted destinations. The predicted destinations are determined by looking at past destinations which are in the same general direction as the driver is currently heading. Accuracy can be improved by taking into consideration the date and/or time. For example, if the driver visits a particular destination every Sunday, and the current day is Sunday and the driver is headed in the direction of the particular destination, then it is more likely that the driver is headed to that particular destination. If the driver typically visits a particular destination at approximately a particular time of day each time the driver visits that particular destination (e.g., noon), and the current time is such that if the driver were headed to that particular destination he/she would reach it at (approximately) noon, then it is more likely that the driver is headed to that particular destination. Routes used to reach the destinations in the destination list can also be used to improve accuracy. For example, if the driver used route 100 to reach a particular destination when the driver has visited the particular destination in the past, then if the driver is currently on route 100 and headed towards the particular destination then it is more likely that the driver is headed to that particular location.

Once a set of predicted destinations is determined (from the driver's current location and direction, by looking at the previous destinations to determine which ones may be a possible destination the driver is currently going to), then a weighting system and algorithms can be used to score each of these predicted destinations to improve accuracy. For example, after the set of predicted destinations is determined, then each predicted destination is scored based on a variety of factors, which include (but not limited to): time of day, day of week, date, route being used, frequency particular destination is visited, prior entry of an upcoming trip to destinations, and any other such characteristic. Each factor can be evaluated and given a score from 0 (no correlation) to 1 (highest correlation). For example, if the driver is headed in a direction of a particular destination the driver has visited every Sunday, and the current day is Sunday, then the day of week score can be very high (e.g., 0.9). If, on the other hand, the current day is Wednesday and the driver is headed in the direction of the particular destination, the day of week score can be 0 (or very low, such as 0.1). The actual score value can be determined using either formulaic approach or by a table of conditions (e.g., if the current day is Sunday, and the driver visited the particular destination on only one previous Sunday then the factor may be 0.1, if the driver visited the particular destination on 5 previous Sundays then the factor would be 0.5, and if the driver visited the particular destination on over 10 previous Sundays and the driver never visited the particular destination on any day other than Sunday then the score would be 0.9).

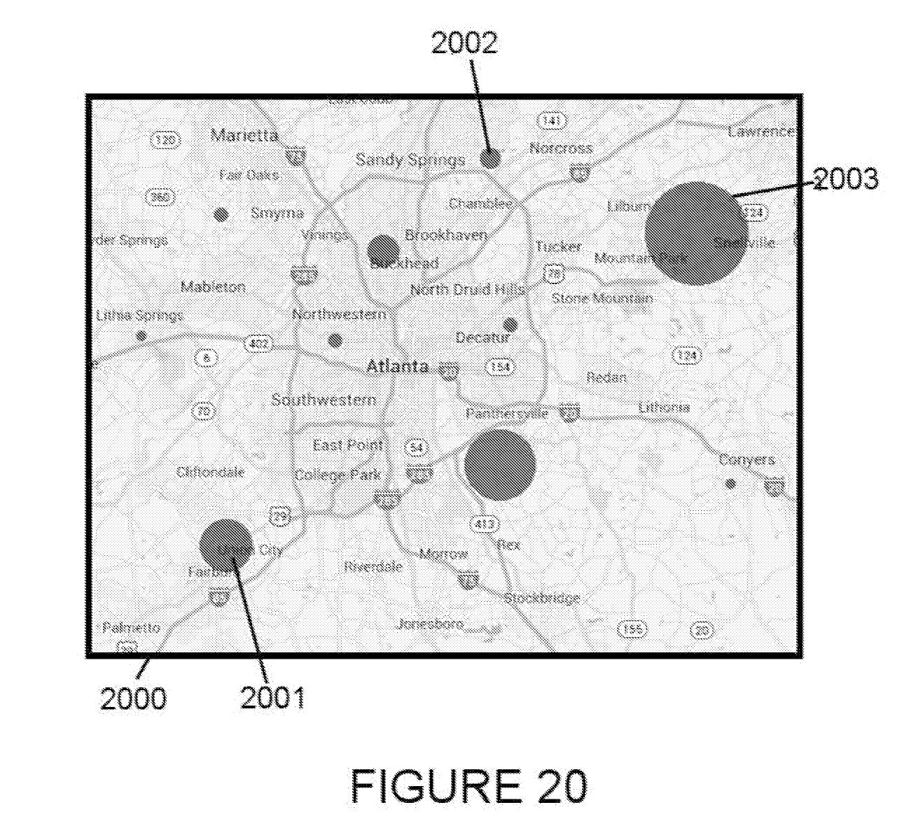

Another factor that can be taken into consideration is the frequency that this driver visited a particular destination in the past. For example, if a few previous destinations are in the general direction of where the driver is driving, then each can be scored based on the number of times the driver visited that particular destination. For example if one of these destinations was visited 20 times since the system starting tracking this driver's locations, and another destination was visited only 3 times, then the former destination would receive a higher score than the latter. The score can simply be the number of previous visits to the particular location (overall or in the past time period such as two years) with a cap of 100 visits, divided by 100. So if a particular location was visited 200 times, the score would be 1. If a particular location was visited 50 times, the score would be 0.5. Of course, any other scoring system can be used as well. This is a simple example. The goal is to provide a numerical score in which the higher the number, the more visits the driver has made to that particular location so the score can be used in a weighting algorithm (like all of the other factors). FIG. 20 shows a heat map with the frequency of previous visits.

When the scores for all of the factors are determined, then a final total can be computed which is a weighted average of all of the scores using predetermined weights. For example, such a formula can be, T (total score)=D*W1+T*W2+R*W3, wherein D is the day of week score, T is the time score, and R is the route score. W1, W2, W3 are weights which can be set by the system designs and can take on any number (greater than 0). Many other factors can be considered as well and this is just one example.

Once the total score T is determined for each potential destination, a set of potential destinations can be determined which only have a respective T greater than a predetermined threshold (e.g., 5). Thus, the result of operation 1801, is a set of predicted destinations which would (in theory) represent a highly probably list of possible destinations the driver is headed. Note that the set would typically only include destinations that the driver has already visited.

From operation 1801, the method proceeds to operation 1802, which determines potential routes for all of the predicted destinations (from operation 1801). Predicted routs can be determines by using a mapping algorithm which starts with the driver's current location and ends with each of the predicted destinations such that the best three (least amount of driving time to reach the respective destination) can be determined and used as the potential routes.

Once the potential routes in operation 1802 are determined, then the method proceeds to operation 1803, which determines (if any) compatible tasks for potential routes. As described herein, compatible tasks are delivery tasks which are generally “on the way” to where the driver is already going. Quantitatively, a compatible task can be defined a delivery task that, after the driver drives from his/her current location to the pickup location, drop-off location, and then the original destination that the driver was heading, would a) not require the driver to driver more than additional W miles from the driving the driver is already doing to get to his/her destination; or b) not require the driver to drive an X percentage increase in miles than the driver is already doing to get to his/her destination; or c) not require the driver to take more than additional Y minutes (can be greater than 60) from the driving the driver is already doing to get to his/her destination; or d) not require the driver to take more than an Z percentage increase in minutes (can be greater than 60) than the driver is already doing to get to his/her destination; The values of W, X, Y and Z can be predetermined (set by the system designers), or alternatively can be set by the driver. Typically, only one of a, b, c, and d would be used as the criteria (although they can be combined as well).

Thus, for example, if criterion a) in the previous paragraph is used to determine a compatible delivery task, and X is set at 15 miles, then compatible tasks would be all tasks which would not take the driver more than 15 miles out of the driver's way before the driver completes the delivery task and reaches the original destination.

The current server would be queried using the potential routes to retrieve any delivery tasks which meet the criterion being used. If no such compatible tasks exist at the current time then no delivery tasks would be prompted to the driver in operation 1804. If too many compatible delivery tasks exist then the set can be reduced, for example, by taking the best 5 (that have the lowest additional miles or time required for the driver).

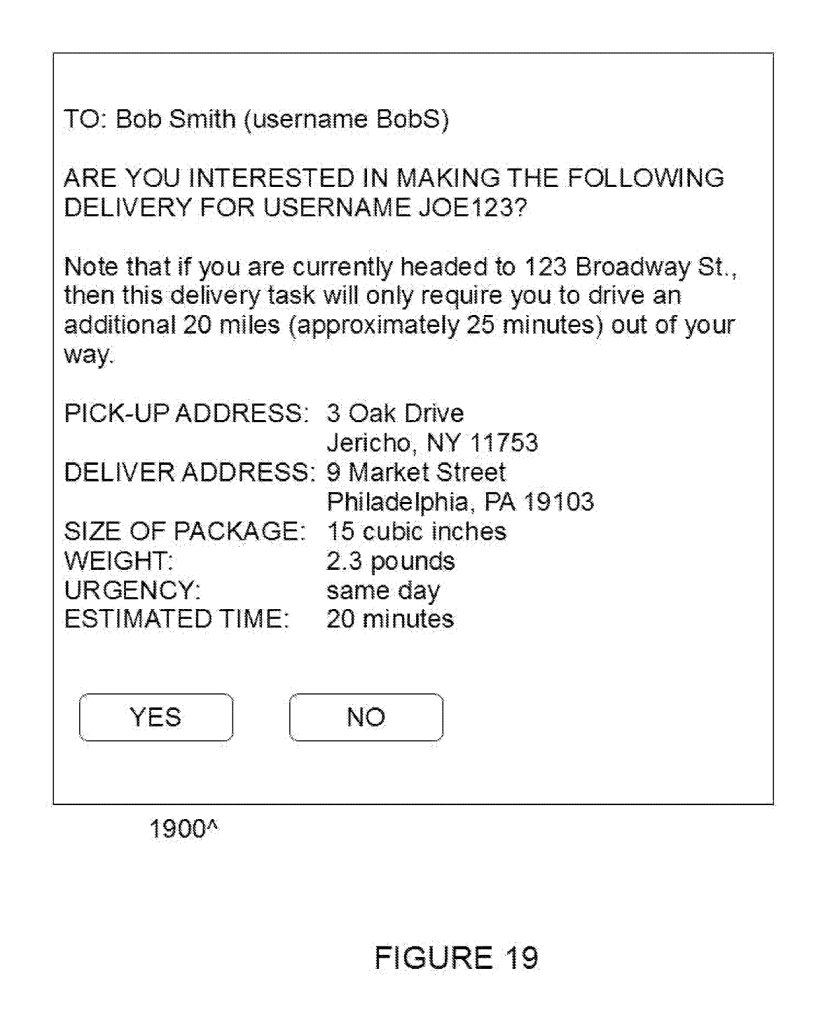

From operation 1803, the method proceeds to operation 1804, which prompts to the driver all (if any) of the compatible delivery tasks determined in operation 1803. The prompt can be done in numerous ways, such as a pop-up screen or text message (see FIG. 19) on the driver's portable computing device (or any other method described herein or known in the art). Alternatively, the compatible delivery tasks can automatically be displayed on the driver's GPS map (see FIG. 9).

FIG. 19 is a sample pop-up message that can be displayed on driver's computing device prompting him or her whether to accept a compatible delivery task, according to an embodiment.

Once a compatible Task is found, the driver can then be prompted with a screen 1900 to inform the driver of the task and receive the driver's yes (acceptance of the task) or no (rejection of the task).

FIG. 20 is a drawing of an example destination heat map, according to an embodiment. In one embodiment, such a heat map would not be displayed to users and is only used by the system to make predictions, etc. In another embodiment, the heat map could be displayed to the users.

A heat map 2000 shows all of the destinations (as circles) in the destination list. The size of the circle represents the frequency of visits by the driver (how many times the driver has visited that particular location). A first location 2003 has the largest circle meaning this particular location has been visited by the driver the most number of times. Visited means the driver has stopped at the location for at least predetermined amount of time (to rule out scenarios where the driver drive past a particular location but did not get out of the driver's car). A second location 2001 contains a circle smaller than the first location 2003 circle, meaning the second location 2001 was not visited as much as the first location. a third location 2002 shows a circle smaller than the first location 2003 circle and the second location 2001 circle meaning that the third location was visited by the driver less often than the first location 2003 and the second location 2001.

Note that the frequency of visits includes all of the recorded history (going back as long as the server/system has recorded data for the driver). In another embodiment, only data from the past predetermined period of time (e.g., two years) is used for all of the predictive calculations herein (FIGS. 17-20). Older location and time data (e.g., more than two years ago) can be discarded.

In a further embodiment, a driver can request a consolidation route. A consolidation route is a route of multiple delivery tasks that are all in proximity of one another so that they can all be efficiently completed in the same time period. The reason a driver would request a consolidation route is if the driver has some free time, instead of making just one delivery, a string of delivery tasks can be presented to the driver so that the driver can complete all of these delivery tasks. Since a driver is paid for each delivery task completed, the driver can make more money completing a consolidation route than a single delivery task. The consolidation route would consolidate numerous delivery tasks in the same region so that the driver does not have to excessively go out of his way. The server would generate a consolidation route and the key is that it would be selected efficiently so that the delivery tasks included would earn the driver a high relative earning per mile driven.

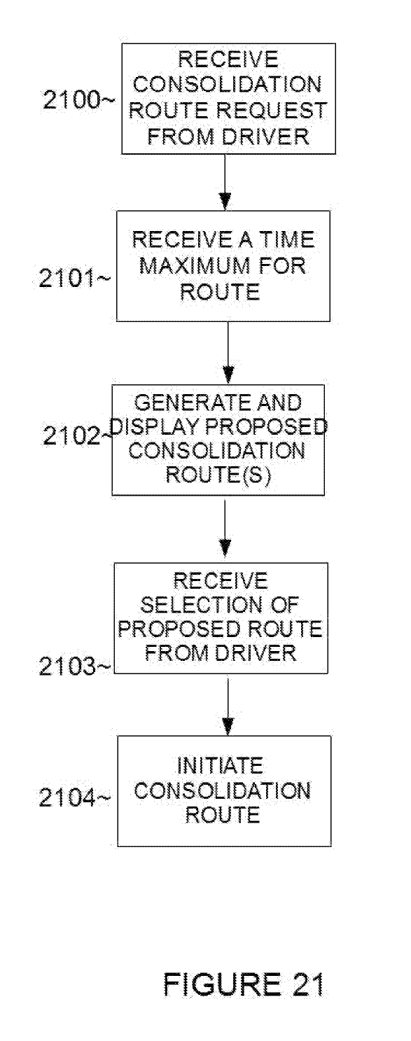

FIG. 21 is a flowchart illustrating an exemplary method of implementing a consolidation route, according to an embodiment.

In operation 2100, a driver makes a request (using a web interface or his/her portable computing device) to generate a consolidation route which can be transmitted to the server.

From operation 2100, the method proceeds to operation 2101, wherein as part of the request (operation 2100) the driver can also include parameters of the desired consolidation route. The parameters can include a time maximum which would be the maximum amount of time that the entire consolidation route would take. Thus, if a driver has two hours of free time and wants to earn money during those two hours then the driver can indicate that the time maximum is two hours so that the server would generate a consolidation route that would not take more than two hours. If a driver has two days free, then the driver can indicate a time maximum of 48 hours which would generate a long consolidation route (which ideally would earn the driver a good sum of money). The driver can also indicate a starting point, which would typically be the driver's home but is not necessarily so. If the driver is currently on the road (and the driver wants the consolidation route immediately) then the starting point would be the driver's current location. The server would generate the consolidation route based on the starting point. The driver can also optionally indicate an ending point, where the driver wants to end up when he is done with the consolidation route. The ending point is where the driver wants to be when the consolidation route is completed. For example, the driver is taking a long interstate drive from his/her house (starting point) to the ending point and desires to deliver some packages on the way to earn some extra money. The driver would also indicate how much room the driver has in his/her vehicle and also the make/model of the vehicle (unless this information is already known to the server). Any other parameters that are relevant to the consolidation route can be prompted for and entered.

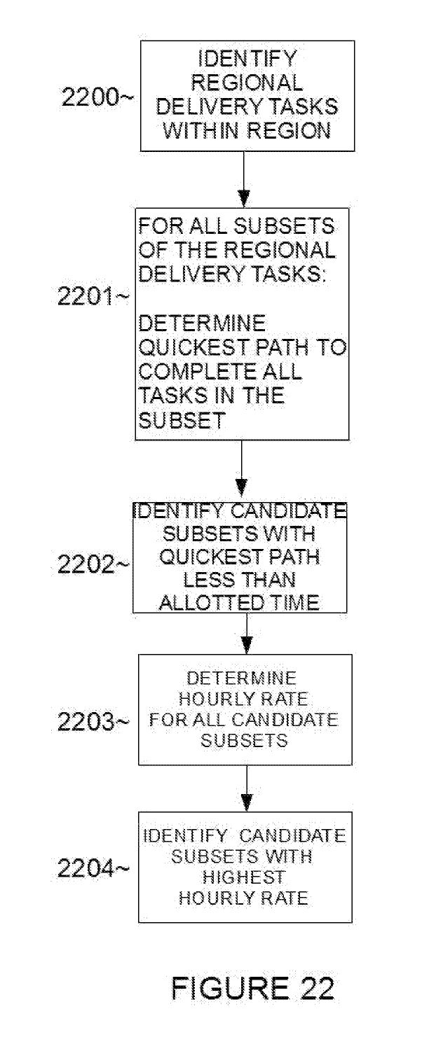

From operation 2101, the method proceeds to operation 2102, wherein the server generates (see FIG. 22) at least one proposed consolidation route which is displayed to the driver. Each proposed consolidation route displays all pickup and drop-off locations along the route and can be displayed in map form.

From operation 2102, the method proceeds to operation 2103, wherein the driver can view the proposed consolidation route(s) and select which one the driver wants to accept (of course if none of them are to the driver's liking then the driver can decline).

From operation 2103, the method proceeds to operation 2104, which initiates the consolidation route (using the proposed consolidation route the driver selected). The consolidation route (selected by the driver) is transmitted to the driver's portable computing device so the driver can be automatically guided along the route. The driver then follows the route, which provides directions to all of the pick-up and drop-off locations. Note that it is not necessary that the all pick-up locations be visited before drop-off locations are visited, they can be all mixed in whatever order minimizes the travel time. Each individual delivery in the consolidation route can be implemented as any delivery task described herein.

FIG. 22 is a flowchart illustrating how a consolidation route is determined, according to an embodiment.

In operation 2200, the server identifies regional delivery tasks which are delivery tasks with pickup and/or drop points within a region bounded by the maximum time specified by the driver in operation 2102. For example, if the maximum time is one hour, then only delivery tasks that have a pickup location and/or drop off location within an hour's drive will be included in the regional delivery tasks.

From operation 2200, the method proceeds to operation 2201, which cycles through all subsets of the regional delivery tasks (determined in operation 2200). If there are 7 regional delivery tasks, then all possible subsets of these 7 delivery tasks are determined and cycled through. For example of these possible subsets, the quickest path (starting at the starting point) to complete all of the regional delivery tasks in the subset is computed. If an ending point is specified (this is optional) in operation 2101 (where the driver wants to end up after completing all deliveries), then the distance will also take into consideration the distance until the driver reaches the ending point once all of the delivery tasks are completed. The quickest path can be computed using known algorithms (i.e. shortest path algorithms) such as used on “MAPQUEST” (or other publicly available mapping program such as GOOGLE MAPS, etc. or independently developed such mapping program) where different points are specified and the shortest driving time is computed to reach those points. The mapping algorithms can take into consideration factors such as traffic, weather, construction, time of day, vehicle gas mileage and any other factors that would affect a shortest path (or shortest drive time) between points. The weighted points would then be geocoded and sent back to the users' phones so they would be incorporated into any navigation program being utilized. Note that the quickest path must be determined with the constraint that all pickup locations for a particular package must be visited before the particular package's drop-off location. The quickest path can be measured in time to complete the respective subset. The time to complete is an estimated time that would take into consideration things like the speed limit of roads used, traffic, weather, time of day etc. Thus, operation 2201 can perform a “brute force” or “exhaustive” search in order to find the quickest path to complete all of the regional delivery tasks in the particular subset. Of course, other methods can be used as well. As an alternative to time to complete, subsets can be measured in miles to complete (which would apply to all other relevant calculations).

Note that the driver's vehicle must have the extra capacity to store all the required packages on the quickest path (deliveries free up space and pickups remove free space). If a quickest path does not afford the driver's vehicle enough physical space in the vehicle to simultaneously carry packages which will be in the vehicle at the same time (according to the path) then this particular quickest path would be disqualified and others would be sought out that did not have the capacity issue. When a consolidation route is requested, the driver would specify how much free space he/she would have in the vehicle.

The result of operation 2201 will be a list (or matrix) of all subsets of the regional delivery tasks which the time it would take to complete the respective delivery tasks for each subset.

From operation 2201, the method proceeds to operation 2202, which identifies the subsets from operation 2201 which all have completion times (quickest path) which are not greater than the maximum time specified in operation 2101, these subsets (if any) become candidate subsets. If there is no such subset then a message is displayed to the driver that no consolidation route is available that matches the driver's request and the method ends. In operation 2101, the driver may also optionally specify a minimum amount of time the driver wishes to spend on the consolidation route. If such a minimum time was specified, then all candidate subsets with completion times shorter than the minimum time would be removed from the candidate subsets, so that the candidate subsets only have completion times falling within the specified range by the driver.

From operation 2202, the method proceeds to operation 2203 which determines the hourly rate for each of the candidate subsets. For each candidate subset, the hourly rate is the total compensation for completing that respective candidate subset divided by the time (in hours) required to complete the respective candidate subset. Of course, higher hourly rates would generally be better for the driver. Drivers are paid by the delivery, not by the hour, but displaying the effective hourly rate may help drivers in deciding whether to accept a candidate subset. Fees to drivers can increase for oversized packages and jobs that require a rush delivery.

From operation 2203, the method proceeds to operation 2204, which identifies and displays to the driver some (e.g., 5 or any other number) of the candidate subsets with the highest hourly rate (now referred to as proposed consolidation routes). The driver can now review each of the proposed consolidation routes, including all of their details including a list of all of their points to visit (pickup locations, drop-off locations, etc.) Each of the proposed consolidation routes is the result of the quickest (or shortest) path determination from operation 2201 (the path to visit all points in the respective consolidation route using the quickest route). If the driver wishes to decline, then of course the driver is not required to select one of the proposed consolidation routes.

If the driver wishes to accept one of the proposed consolidation routes, then the driver can use a graphical user interface (GUI) on their mobile device to select the one the driver wishes to select. Now, the driver's portable device will display the route for the selected consolidation route and provide navigation instructions for the complete consolidation route (which includes directing the driver to the ending point if one was specified).

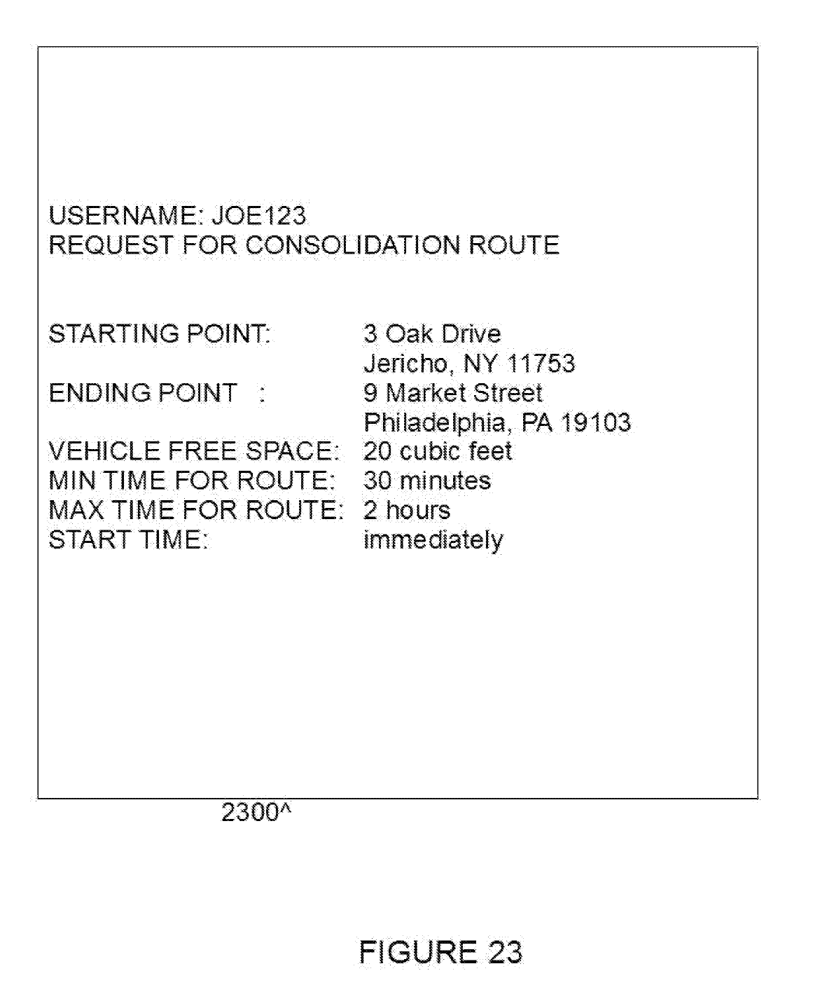

FIG. 23 is an example of a dialogue box which illustrates a driver's request for a consolidation route, according to an embodiment.

When a driver requests a consolidation route, the driver would enter parameters in his/her computing device (which would ultimately get transmitted to the server) for the desired consolidation route. Such parameters can include any relevant information, including the starting point address, the ending point address (optional), how much free space is in the vehicle, the minimum time (or distance) that the driver wants to spend driving on the consolidation route (optional), the maximum time that the driver wants to spend driving on the consolidation route, and the desired start time.

Other information is not required to be entered by the driver because the server would already know this information about the driver by virtue of the driver having registered an account with the server (where the driver would have already provided this information). Such known information can include the driver's make and model of the car, telephone number, bank account number, driver's home address, and any other relevant information about the driver.

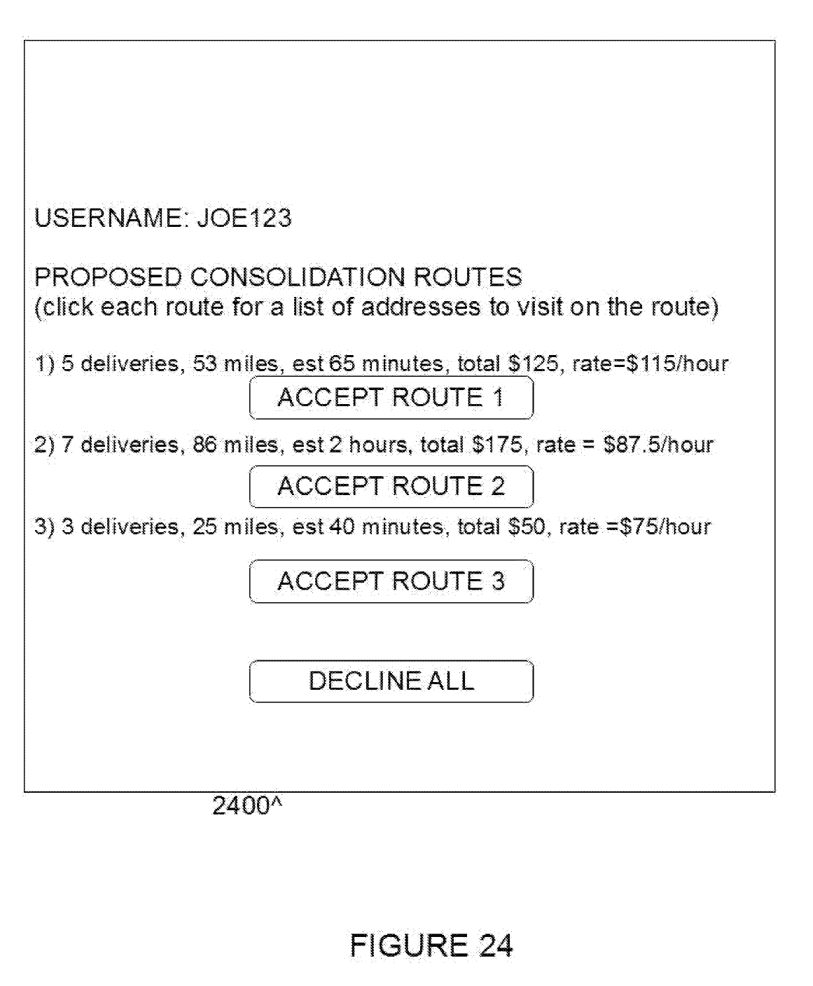

FIG. 24 is an example of an output window showing proposed consolidation routes, according to an embodiment.

When the server causes to be displayed on the driver's output device a list of proposed consolidation routes (operation 2102), the driver can choose one of the proposed consolidation routes based on its properties. Proposed consolidation route window 2400 shows the proposed consolidation routes that were determined using the methods described herein. The information shown for each proposed consolidation route can include: how many deliveries (packages) are on the route, the miles driven for the route, the estimate time it will take to complete the route, the total compensation to be paid for completing that route, and the hourly rate (total compensation/estimated time). Any other relevant information about the proposed consolidation route can also be displayed.

The driver can click a particular proposed consolidation route to receive a detailed list of every point on that route. The driver can also accept one of these routes by pressing the respective button. The driver can also decline all of these by pressing the ‘decline all’ button.

It is noted that the tax code may allow for deductions for expenses (e.g., gas) related to deliveries (since it is a business). Thus, a driver can request a consolidation route and specify a destination in another state that the driver plans to drive to anyway, and the driver (in addition to getting paid for the delivery) may also be able to deduct the travel expenses since it is in furtherance of a business venture (the delivery).

In a further embodiment, the system described herein can also be used to assist a driver that is in distress (e.g., out of gas, flat tire, or just needs help for any reason). All of the drivers known to the server can be located and the closest one to the distressed driver can be requested to help the distressed driver. In this manner, an emergency network can be maintained to help drivers. Typically drivers would have to be registered with the server/system in order to request help.

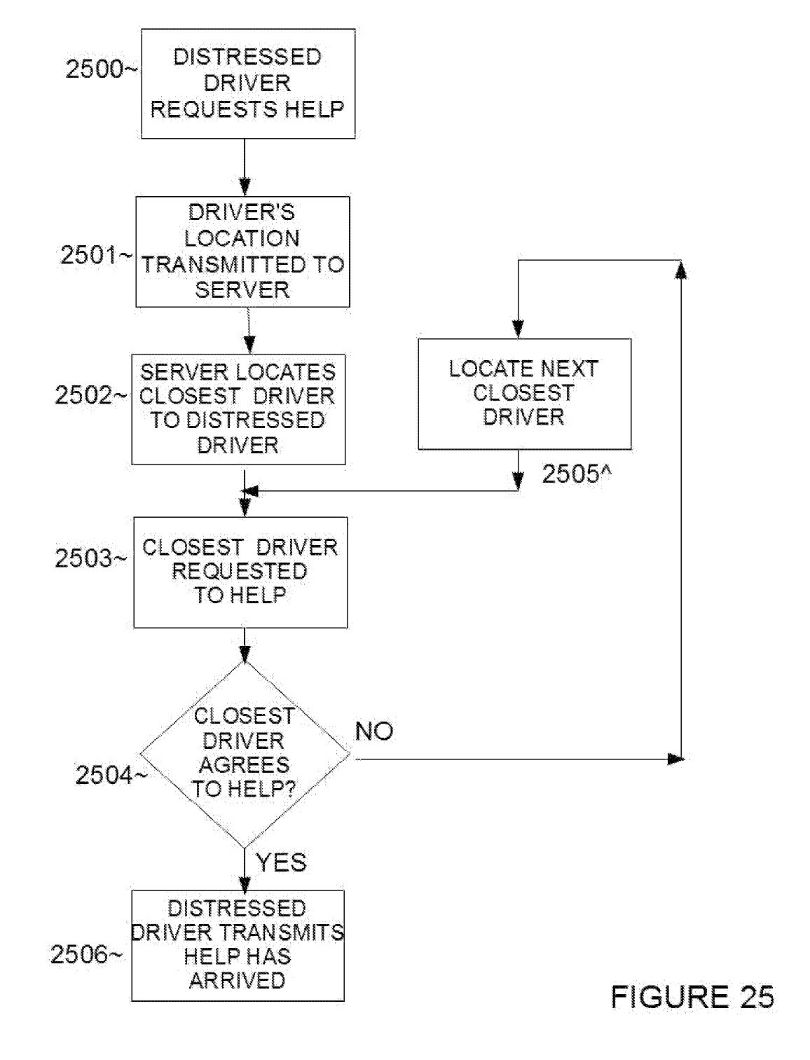

FIG. 25 is a flowchart illustrating an exemplary method of implementing a distress network, according to an embodiment.

The method can begin with operation 2500, wherein a distressed driver requests help. The distressed driver can use his/her portable computing/mobile device to indicate that he/she is in distress and needs assistance.

From operation 2500, the method proceeds to operation 2501, which transmits the distressed driver's location to the server. The distressed driver can be located (using any of the location methods described herein).

From operation 2501, the method proceeds to operation 2502, wherein the server locates the closest driver to the distressed driver. The locations of all of the drivers can be determined (using any locating method).

From operation 2502, the method proceeds to operation 2503, which transmits a request to the closest driver to help the distressed driver along with the location of the distressed driver. The request can be presented in any form, instant message, text message, phone call, etc.

From operation 2503, the method proceeds to operation 2504, which determines whether the closest driver has agreed to help the distressed driver or not.

If in operation 2504, the distressed driver does not agree to help (or fails to respond to the request) then the method proceeds to operation 2505, which locates the next closest driver to the distressed driver (which is now considered the closest driver in operation 2503). Each driver that has declined the request to help (or failed to answer) would no longer be considered while the method continues to be performed until a driver that agrees to help the distressed driver is found. When a next closest driver is located, then the method proceeds to operation 2503 which requests the next closest driver to help as described herein.

If in operation 2504, the closest driver agrees to help, then the method proceeds to operation 2506 which transmits to the distressed driver that the closest driver has agreed to help and the location of the closest driver. The cell phone number of the closest driver can also be transmitted to the distressed driver (and vice-versa). When the closest driver arrives to the distressed driver, then the distressed driver can press a button on the distressed driver's computing device that the closest driver has arrived so that the server can record the transaction. Once the distressed driver and the driver that has agreed to help have each other's phone numbers then they can both communicate with each other and address the situation between themselves. Drivers that help out distressed drivers can receive points (or other incentives such as a “hero” badge) by the server so that their good deed is recorded and visible by other users of the system. Badges (such as the “hero” badge”) can be displayed on the driver's profile so that when the profile is viewed (such as when that driver is being considered for a job) it would be displayed (thereby improving their reputation).

It is noted that the drivers coming to help the distressed drivers are not tow truck drivers, police, or other professionals but are civilians with a regular vehicle responding to assist the distressed driver within the network/system. The distressed drivers would typically have to be registered users of the system in order to avail themselves of the assistance described herein

In a further embodiment, a sender can choose to only have the sender's friends (or a particular degree of separation such as friends or friends of friends) deliver their packages. The friends can be based on connections from the server itself or from an outside social network site such as FACEBOOK. For example, a sender's friends (and optionally friends of friends) can be imported from FACEBOOK, and the server can be queried to identify which of these parties have accounts on the server. Thus, when a sender wants to send a package using only the sender's friends (and friends of friends) then the delivery task will be transmitted only to these parties (friends or friends of friends). Someone who does not qualify as a sender's friend or friend of friend would not be allowed to deliver for the sender. In this way, a sender can be assured that only people the sender trusts would be delivering their package. In an embodiment, utilizing only ones friends (on FACEBOOK or other social networking site) can be achieved upon payment of a fixed yearly fee. For example, a user/sender of the system can be a yearly fee which then enables the functionality of being able to import that user's friends from an outside web site (e.g., FACEBOOK, or connections on LINKEDIN, etc.) so that only friends or connections would qualify to deliver for the sender (receiver, or manager arrange from a delivery).

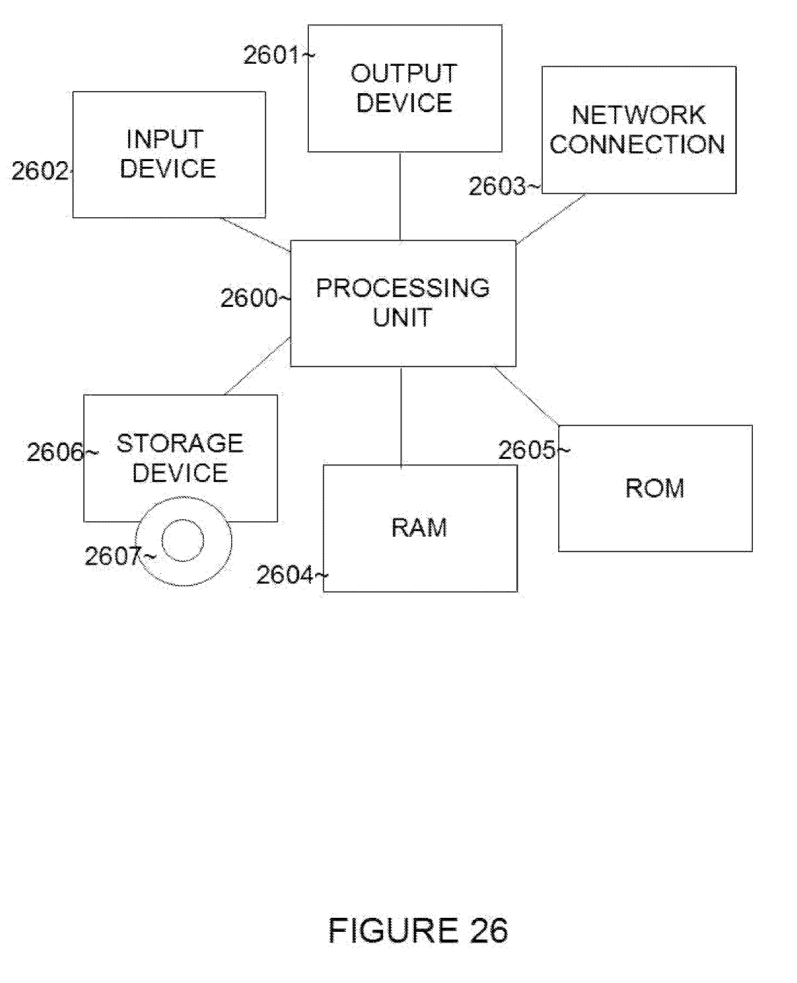

FIG. 26 is a block diagram illustrating one example of computer hardware that can be used to implement any computer used, according to an embodiment. The computer can also be any computing device, such as the server, cellular phone, GPS device, portable computing device, personal computer, tablet, etc. All of the methods/features described herein can be performed by a program that can be installed as software (e.g., an app) on the device. FIG. 26 can be considered an electrical circuit

A processing unit 2600 (such as a microprocessor and any associated components such as cache, bus, etc.) is connected to an output device 2601 (such as an LCD monitor, touch screen, CRT, etc.) which is used to display any aspect of the method (including any information described herein) and an input device 2602 (e.g., buttons, a touch screen, a keyboard, mouse, etc.) which can be used to input any information from any user. Multiple such processing units can also work in collaboration with each other (in a same or different physical location). All methods/features described herein can be performed by the processing unit 2600 by loading and executing a stored program comprising respective instructions to perform the methods/features. The processing unit 2600 can also be connected to a network connection 2603, which can connect the processing unit to a computer communications network such as the Internet, a LAN, WAN, etc. The processing unit 2600 is also connected to a RAM 2604 and a ROM 2605. The processing unit 2600 can also be connected to a storage device 2606 which can be a DVD-drive, CD-ROM drive, flash memory, etc. A non-transitory computer readable storage medium 2607 (CD-ROM DVD, flash memory, RAM, etc.) can store a program which can control the processing unit 2600 to perform any of the methods/features described herein and can be read by the storage device 2606.

While one processing unit is shown, it can be appreciated that one or more such processor can work together (either in a same physical location or in different locations) to combine to implement any of the methods/features described herein. Programs and/or data required to implement any and all of the methods/features described herein can all be stored on any non-transitory computer readable storage medium (volatile or non-volatile, such as CD-ROM, RAM, ROM, EPROM, microprocessor cache, etc.)

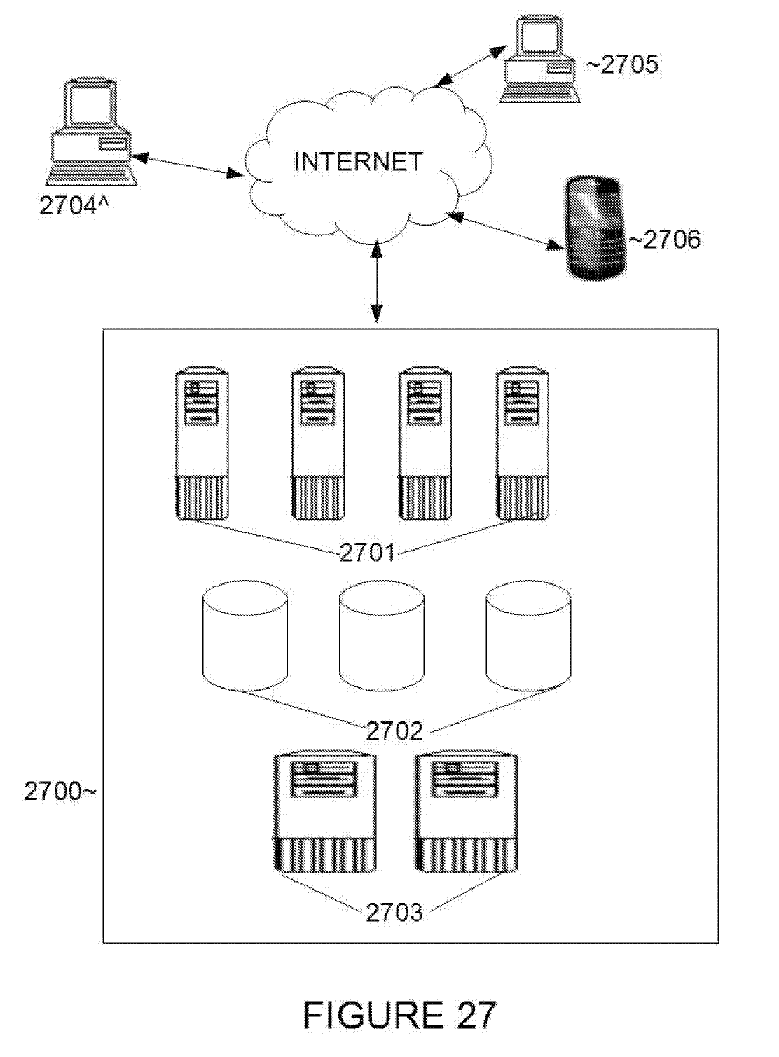

FIG. 27 FIG. 27 is a block diagram illustrating the system and more particularly a production system, according to an embodiment. A production system 2700 is a secure system and what implements the entire system and communicates with all users over the internet. The productions system 2700 can be considered to be an electrical circuit.

Application servers 2701 serve all of the downloads, communications, etc., to all of the users to the internet and also receive all communications from the users. Persistent storage 2702 stores data for all current processes and operations and other temporary and permanent data. A data warehouse 2703 stores long term data, such as all user location history (and any other data described herein). All components can communicate with one another even though such communications are not explicitly shown

Users 2704, 2705, 2706 (on a cell phone) are shown although there can be many other simultaneous users (e.g., 4 to 100, 100 to 2000, over 2000, etc.) The system simultaneously processes all such users and their applications, processes, communications, etc., even though all such users are in different physical locations all around the country. Production system 2700 is an expanded view of server 504 which can also be referred to as the “system.” The different types of users (e.g., drivers, senders, managers, receivers, etc.) can utilize the system in any proportion simultaneously (in other words there can be any number of each of these types of users. For example, any number, such as 1-10, at least 10, 10 to 100, more than 100, 1 to 1,000,000 simultaneous drivers can be location tracked in real time with their locations stored in the server/database simultaneously even though they are located all around the country.

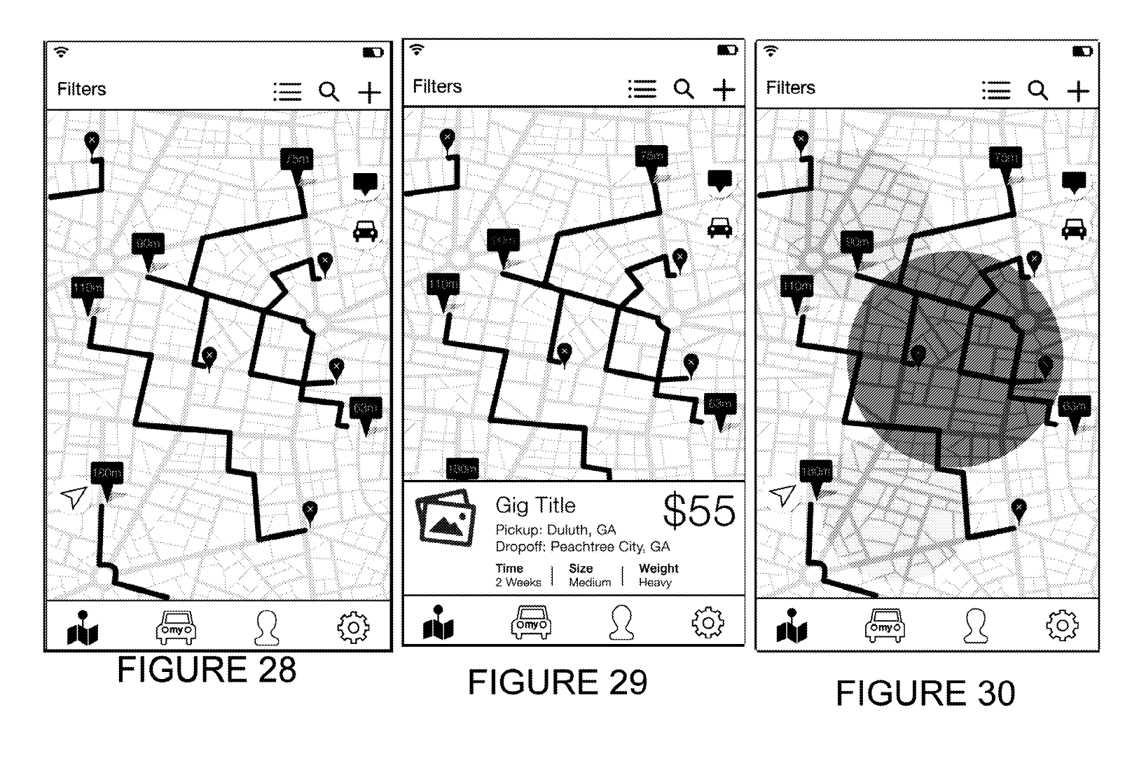

FIG. 28 is an exemplary mobile device screen illustrating a default home view, according to an embodiment. The default “home” view is the map showing tasks (also referred to as gigs) around the user's current location. The user can swipe & zoom around the map to see other tasks.

FIG. 29 is an exemplary mobile device screen illustrating a default home view with task information selected and highlighted, according to an embodiment. By tapping a pin, the user will be able to view the task summary. By tapping the task summary, the user can see the task detail.

FIG. 30 is an exemplary mobile device screen illustrating a default home view with task data graphically displayed, according to an embodiment. The user can toggle on/off the task data on the map and also the heat map. The heat map shows the density of where the user has physically been on the map. During the first time used, the difference between these will be explained.

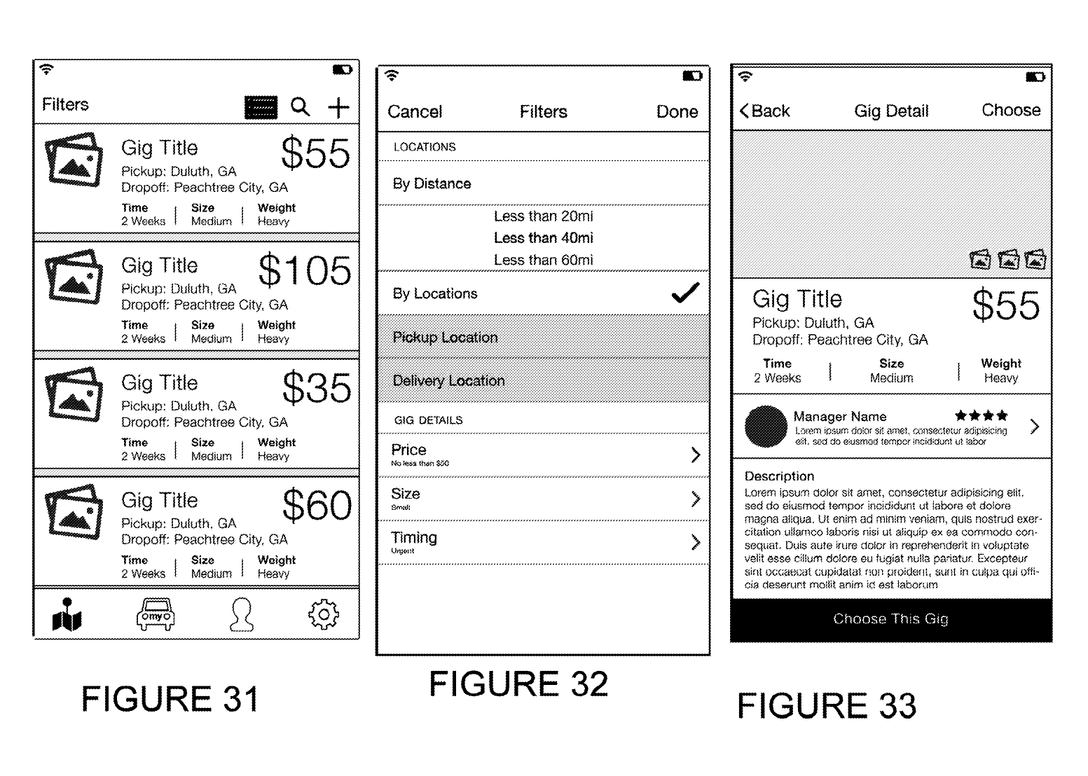

FIG. 31 is an exemplary mobile device screen illustrating a task list view, according to an embodiment. The user can switch the data to be displayed in a list view. It will be the same exact tasks displayed on the map, but simply displayed in a list view. When a task is clicked then details of that task are displayed.

FIG. 32 is an exemplary mobile device screen illustrating a filtering screen for a mapping screen, according to an embodiment. When the user clicks on filters, this view overlays (transitioning from the bottom) the current view. The user can filter the data by various criteria in both map and list views.

FIG. 33 is an exemplary mobile device screen illustrating a task detail summary screen, according to an embodiment. When the user taps on a task summary in either the map or list, they will see the task details. If the user hasn't already registered as a driver, they will be asked to at this time.

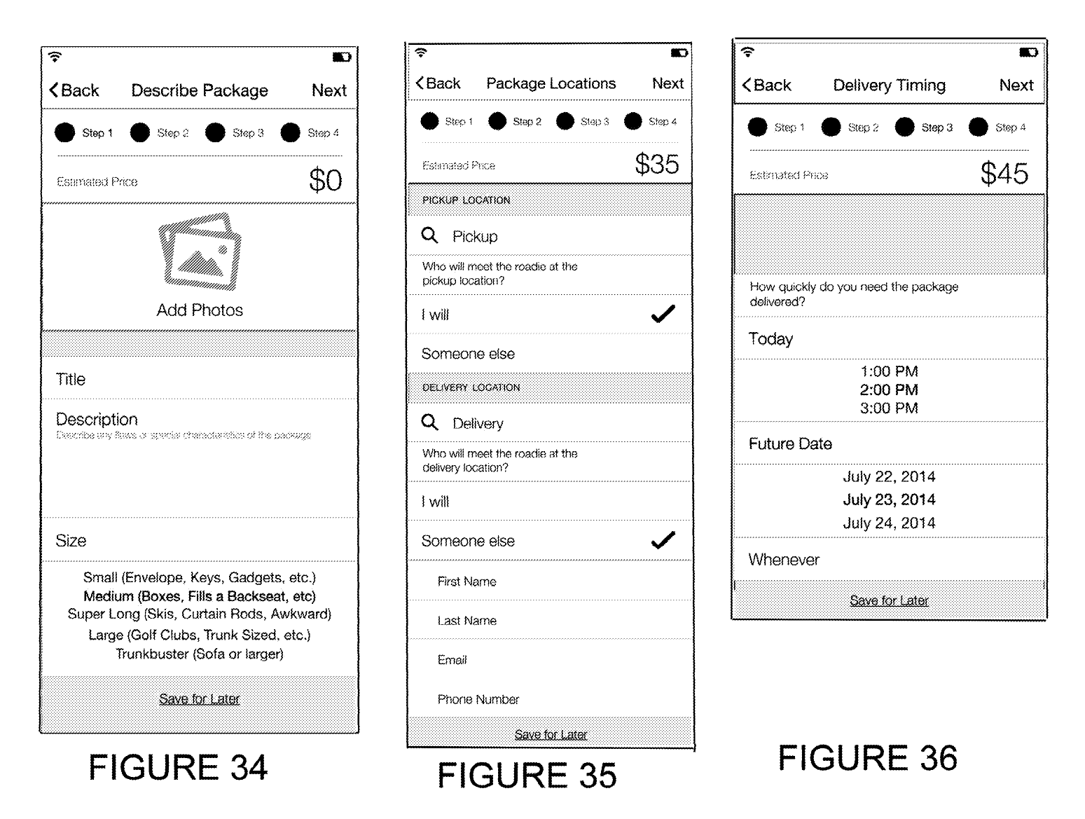

FIG. 34 is an exemplary mobile device screen illustrating one aspect of a task creation, according to an embodiment. When the user taps the create task button, they will enter into the 4-step process of creating a task. The app will automatically save their progress as they go, but the “Save for Later” allows them to leave the process without finishing or having to go back repeatedly.

FIG. 35 is an exemplary mobile device screen illustrating another aspect of a task creation, according to an embodiment. The price should update as the user goes through each step. The locations will be obtained by searching real map location data.

FIG. 36 is an exemplary mobile device screen illustrating a further aspect of a task creation, according to an embodiment.

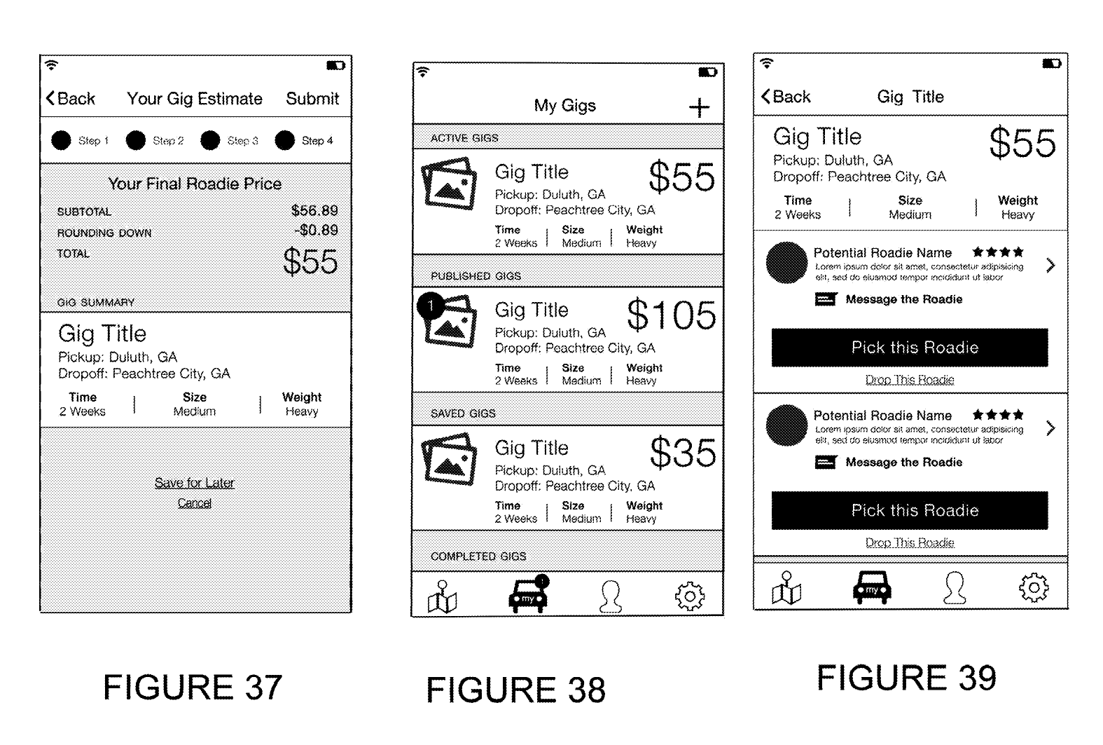

FIG. 37 is an exemplary mobile device screen illustrating an additional aspect of a task creation, according to an embodiment. This reflects the final price and competitors' prices. The user can click submit. If they have not registered or logged in, they would be required to do that at this time.

FIG. 38 is an exemplary mobile device screen illustrating a user's task list, according to an embodiment. The user's tasks are displayed by status on this view. When action has been taken on a task, a notification jewel will display in a tab bar and on the task.

FIG. 39 is an exemplary mobile device screen illustrating a task acceptance screen, according to an embodiment. The manager can decide to accept the driver or drop the driver by looking at the driver's profile and messaging with the driver.

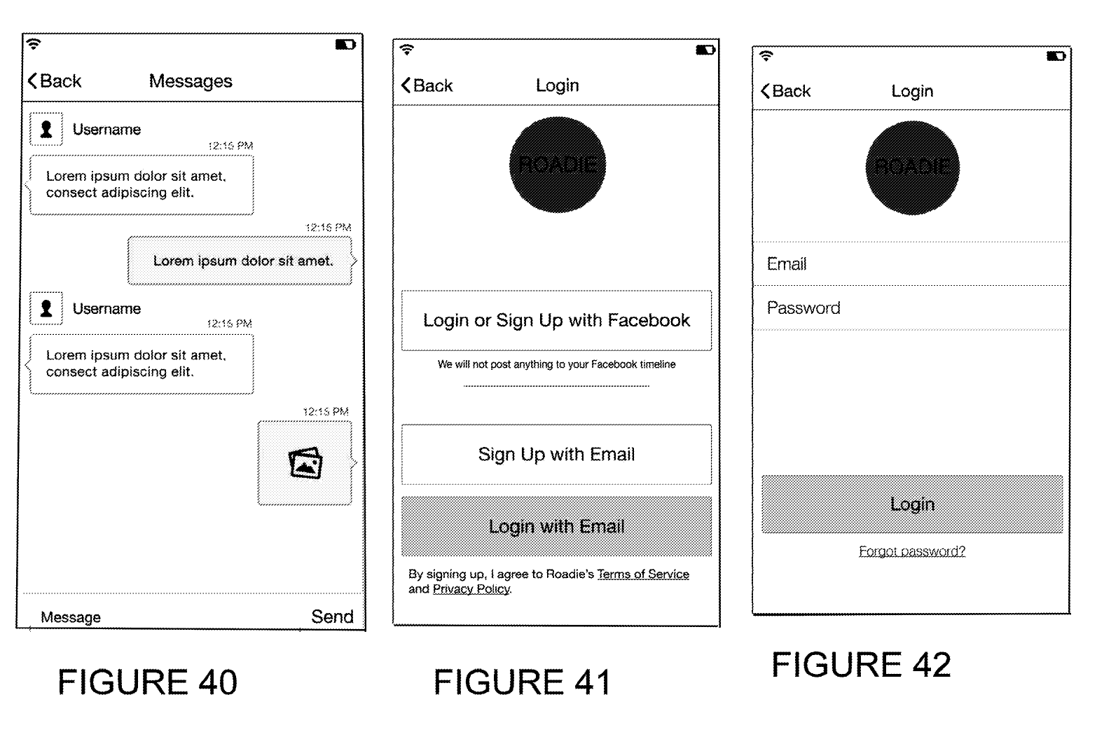

FIG. 40 is an exemplary mobile device screen illustrating a task messaging system, according to an embodiment. All messaging can be tied to a particular task such that the driver and the receiver (or manager or sender) can chat with each other.

FIG. 41 is an exemplary mobile device screen illustrating a login or registration screen if the user is a social media user, according to an embodiment. The user can use their Facebook account to quickly register or login. The advantage is they don't have to remember another password, type in their email, or enter a profile pic.

FIG. 42 is an exemplary mobile device screen illustrating a login screen if the user is not a social media user, according to an embodiment. This is a login screen for those that do not use Facebook to authenticate.

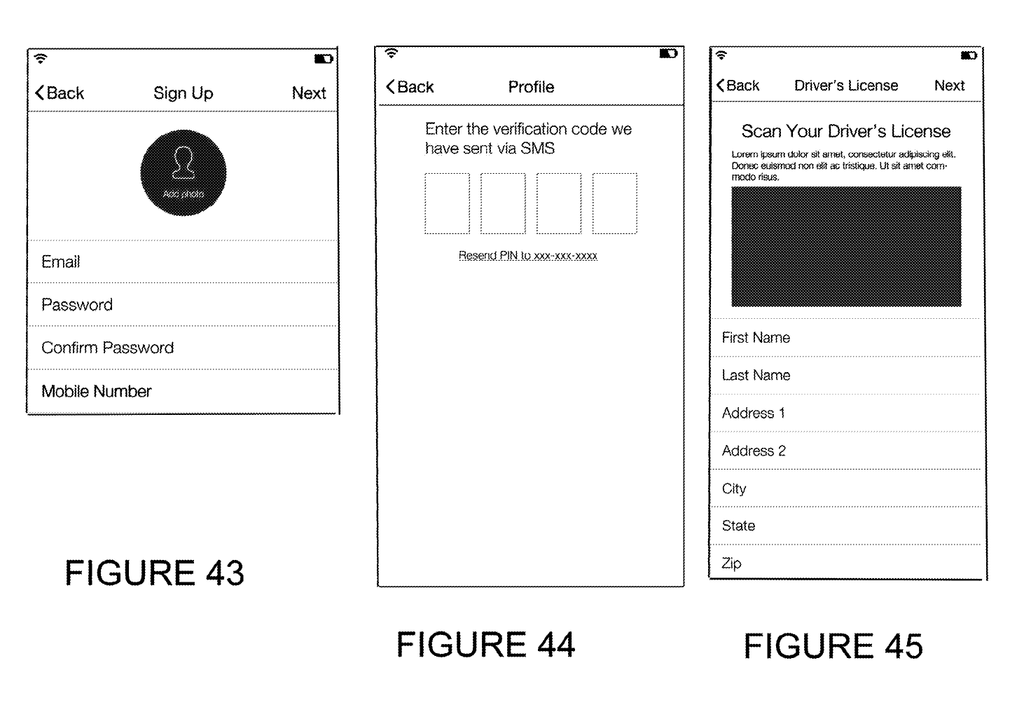

FIG. 43 is an exemplary mobile device screen illustrating a user information entry screen, according to an embodiment. Every user typically goes through this step to register, no matter which path they are on for registration. Adding a photo is optional. All other fields are required.

FIG. 44 is an exemplary mobile device screen illustrating a verification screen, according to an embodiment. A code can be texted to the user's mobile phone which the user then types back into the application to verify that the user's phone number is correct. Depending on system preferences, a user may have to be verified before they can request or participate in a task (including serving as a driver).

FIG. 45 is an exemplary mobile device screen illustrating a screen to capture a sender's driver's license information, according to an embodiment. This can also be used for a driver as well or any other user. A driver's license is scanned (a picture is taken using the user's mobile phone) and the data from the license is optically recognized auto-filled into the app (e.g., name, driver's license number, etc.) If the user is younger than 18, they should receive an error message here and cannot proceed.

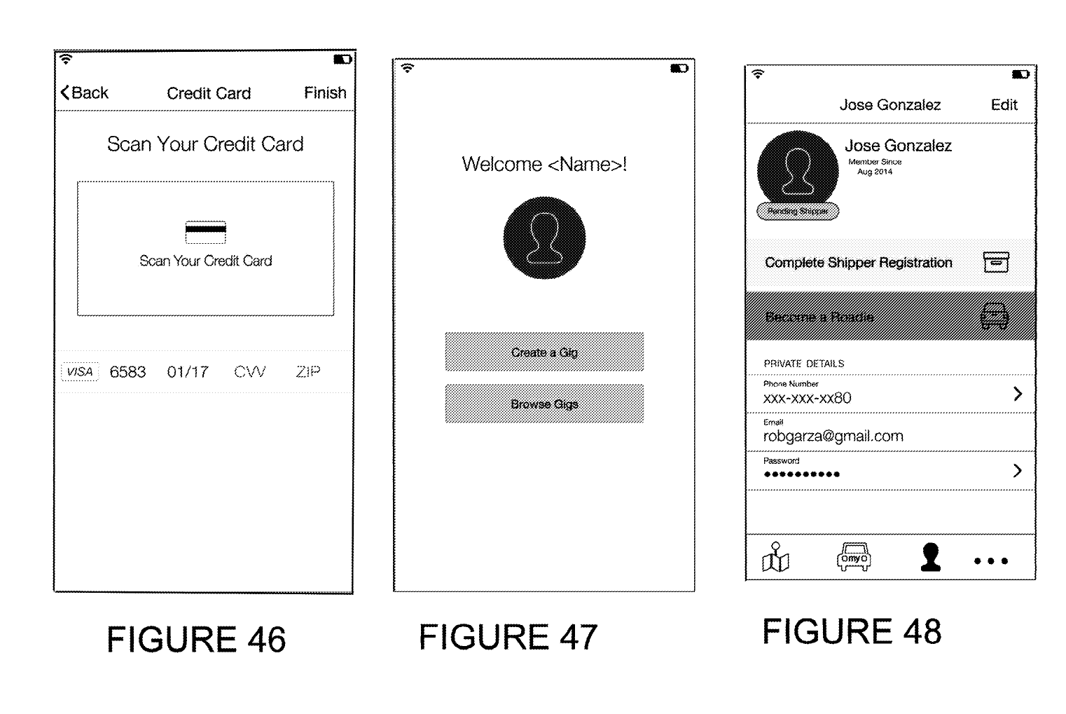

FIG. 46 is an exemplary mobile device screen illustrating a screen to capture a sender's credit card information, according to an embodiment. A picture of the credit card can be taken, the data optically recognized, and auto-filled into the application (e.g., credit card number, expiration date, etc.)

FIG. 47 is an exemplary mobile device screen illustrating a welcome screen for a new user who has successfully registered, according to an embodiment.

FIG. 48 is an exemplary mobile device screen illustrating an incomplete registration screen, according to an embodiment. If the user drops out of the registration flow at any point (by switching apps, exiting app, etc.) show their incomplete profile and complete process via tapping a button. Or if they try to create a task, then they are returned to complete registration.

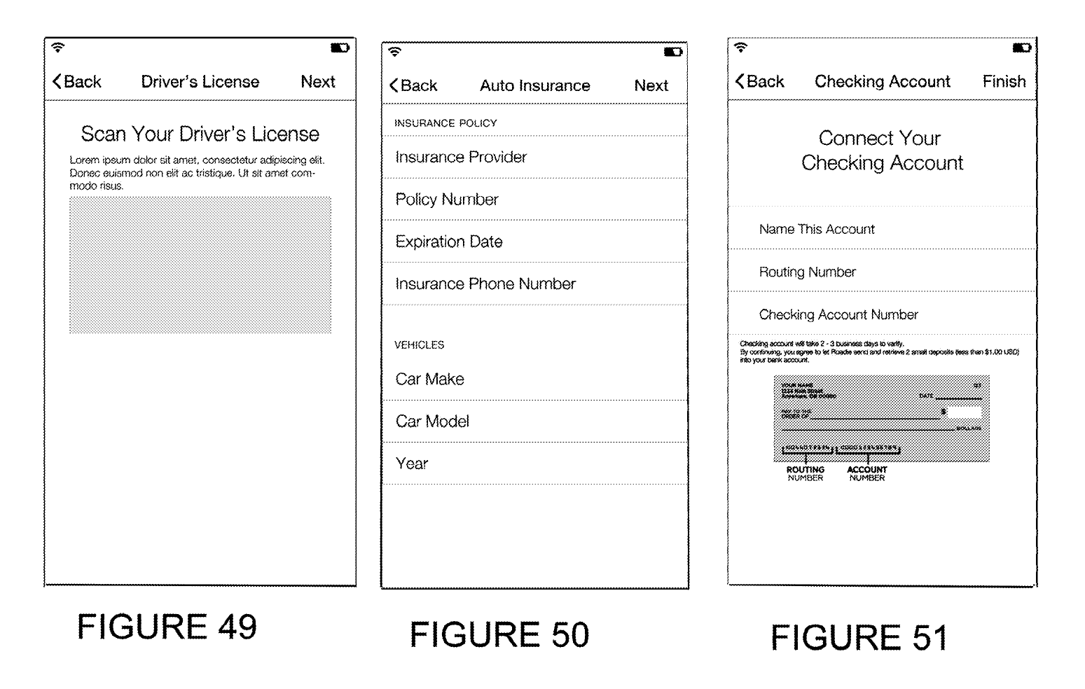

FIG. 49 is an exemplary mobile device screen illustrating scanning a driver's license, according to an embodiment. For the driver, the scanning of the driver's license is to verify age (must be 18) and to conduct a driver's license verification check (make sure the license is valid). If the driver is under 18, they would receive an error message and cannot proceed.

FIG. 50 is an exemplary mobile device screen illustrating a vehicle information entry screen, according to an embodiment. The driver can add a vehicle he/she will be using here.

FIG. 51 is an exemplary mobile device screen illustrating a checking information entry screen, according to an embodiment. The user enters their checking information. This account can be used to receive (e.g., for a driver completing a task) and make (e.g., for a sender sending a package) payments to the system.

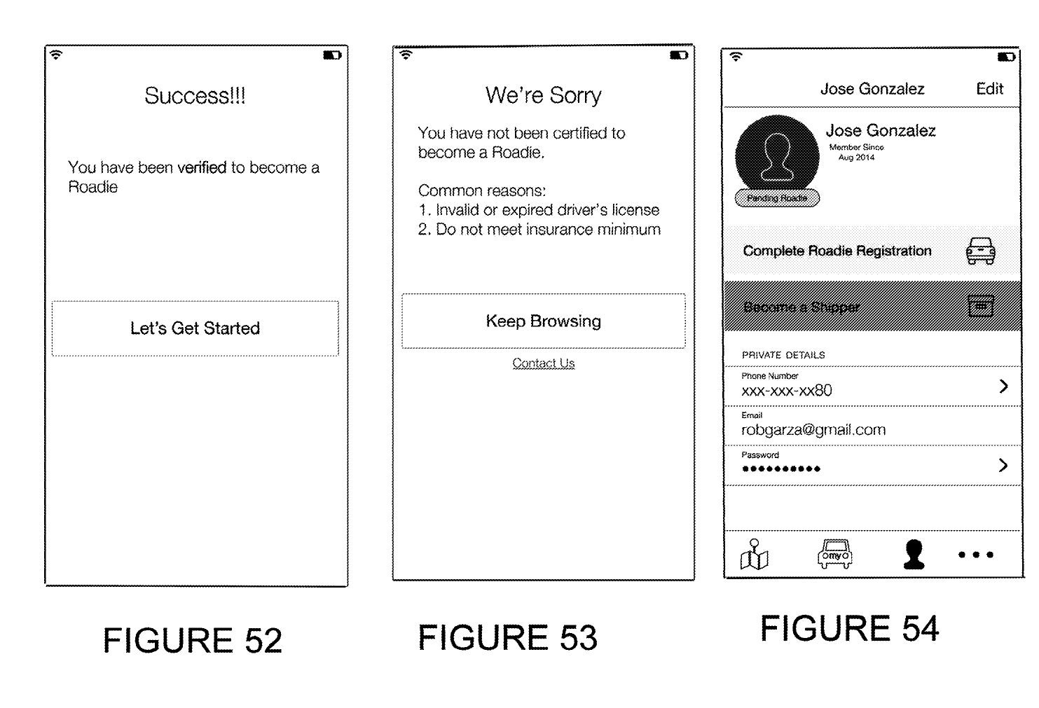

FIG. 52 is an exemplary mobile device screen illustrating a successful verification screen, according to an embodiment.

FIG. 53 is an exemplary mobile device screen illustrating an unsuccessful verification screen, according to an embodiment. For example, if a driver's license turns out to be invalid it will result in an unsuccessful verification. The driver would not be allowed to perform any task until the driver is verified.

FIG. 54 is an exemplary mobile device screen illustrating an incomplete user information screen, according to an embodiment. If the user drops out of the registration flow at any point (by switching apps, exiting app, etc.) then they can complete the registration process at a later time (e.g., once they try to initiate a task).

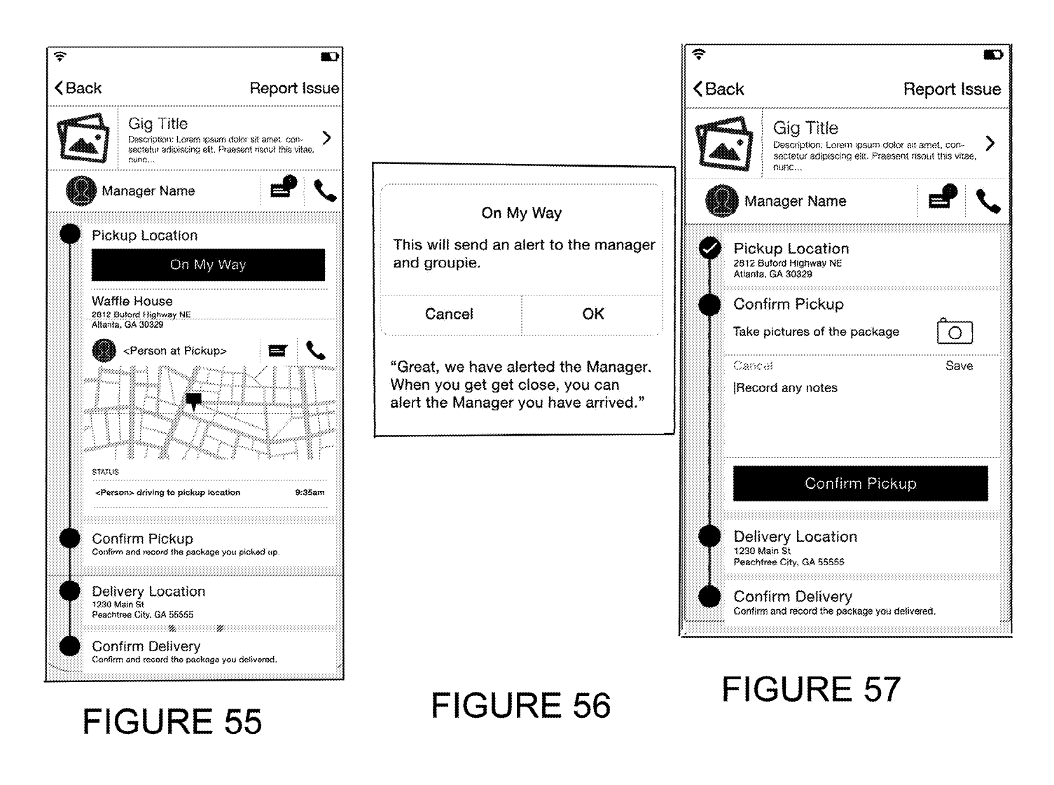

FIG. 55 is an exemplary mobile device screen illustrating a task information screen displaying pickup information for a driver, according to an embodiment.

FIG. 56 is an exemplary mobile device screen illustrating an alert notification screen for a driver during a task, according to an embodiment.

FIG. 57 is an exemplary mobile device screen illustrating a pickup confirmation screen for a driver, according to an embodiment.

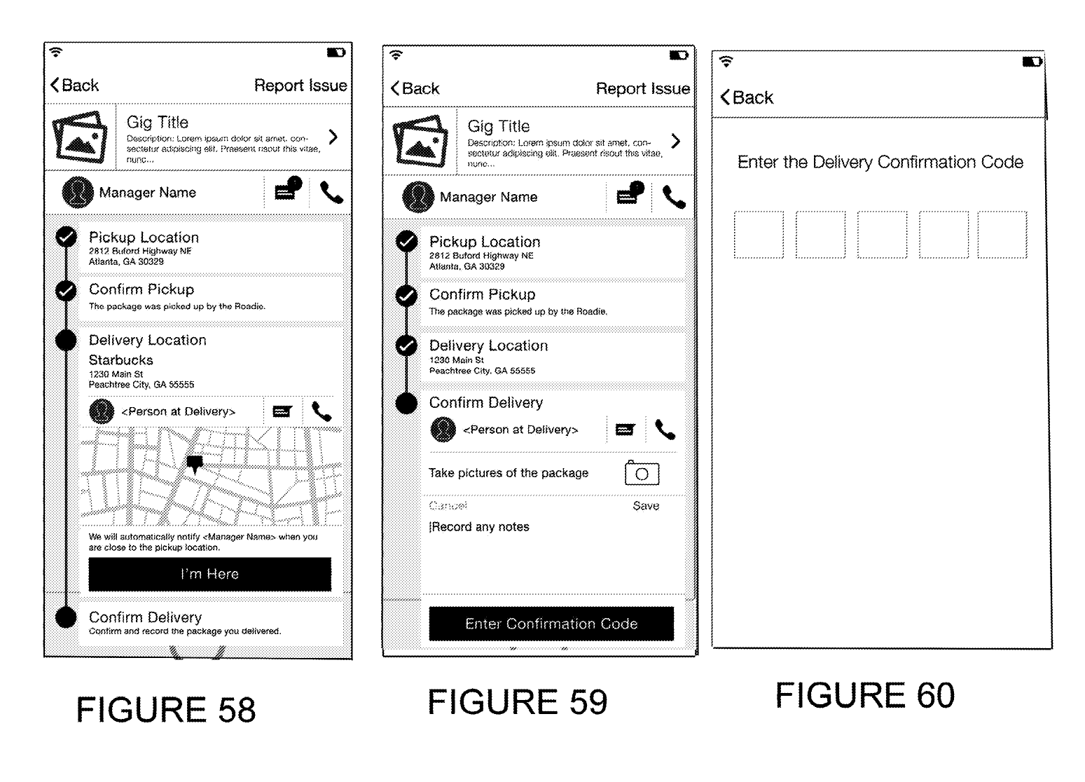

FIG. 58 is an exemplary mobile device screen illustrating a delivery location screen for a driver, according to an embodiment.

FIG. 59 is an exemplary mobile device screen illustrating a delivery confirmation screen for a driver, according to an embodiment. Once the driver delivers a package, this screen can be used to confirm the package has been delivered to the receiver.

FIG. 60 is an exemplary mobile device screen illustrating a delivery code entry screen for a driver, according to an embodiment. The driver can enter a code that was provided to the receiver and spoken to the driver (or the receiver) to confirm the package has been delivered to the receiver.

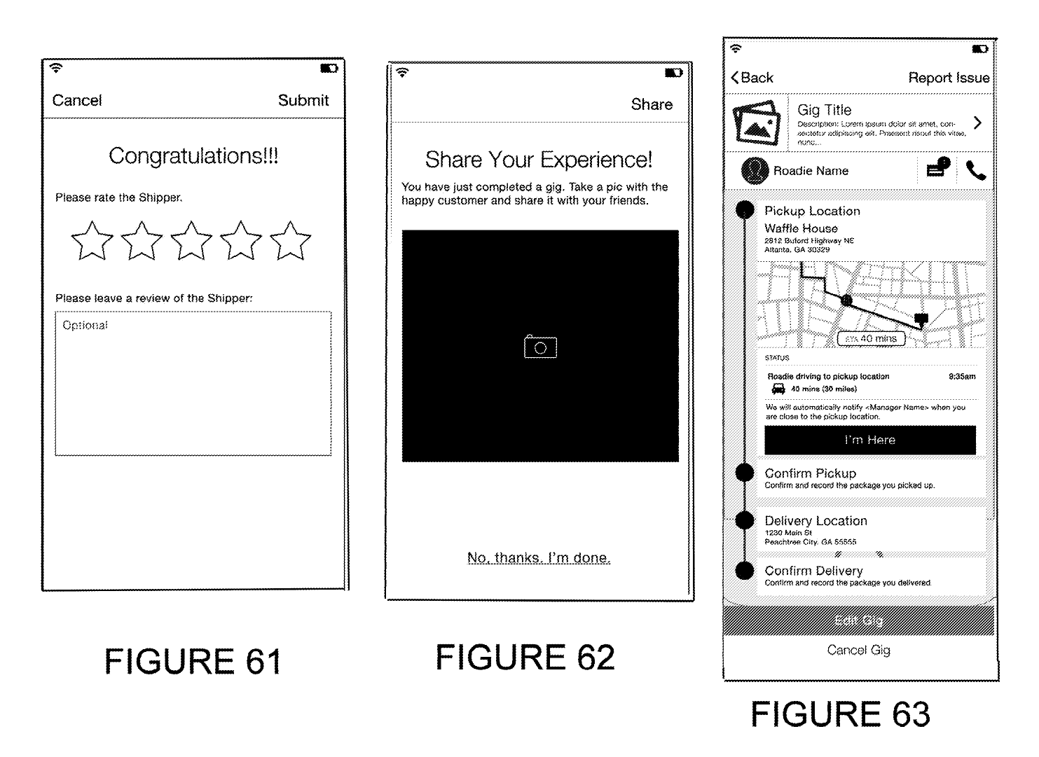

FIG. 61 is an exemplary mobile device screen illustrating a rating screen to be filled out by a driver, according to an embodiment. Ratings of senders can be averaged and displayed on the senders' profile.

FIG. 62 is an exemplary mobile device screen illustrating a commenting screen for a driver, according to an embodiment.

FIG. 63 is an exemplary mobile device screen illustrating a task information screen displaying pickup information for a sender (or manager, receiver, etc.), according to an embodiment. Once the pickup has been confirmed, the sender or manager can no longer edit or cancel the task.

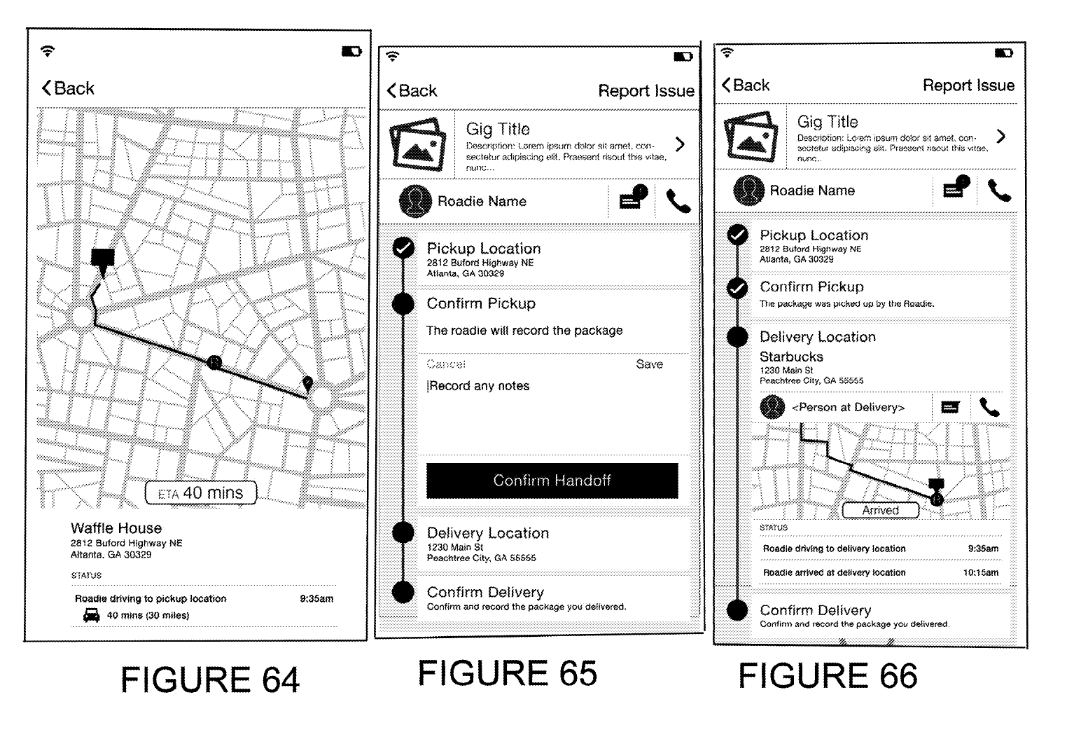

FIG. 64 is an exemplary mobile device screen illustrating a task information screen displaying estimated time of arrival information for a sender, according to an embodiment.

FIG. 65 is an exemplary mobile device screen illustrating a pickup conformation screen for a sender, according to an embodiment.

FIG. 66 is an exemplary mobile device screen illustrating a delivery location screen for a sender, according to an embodiment.

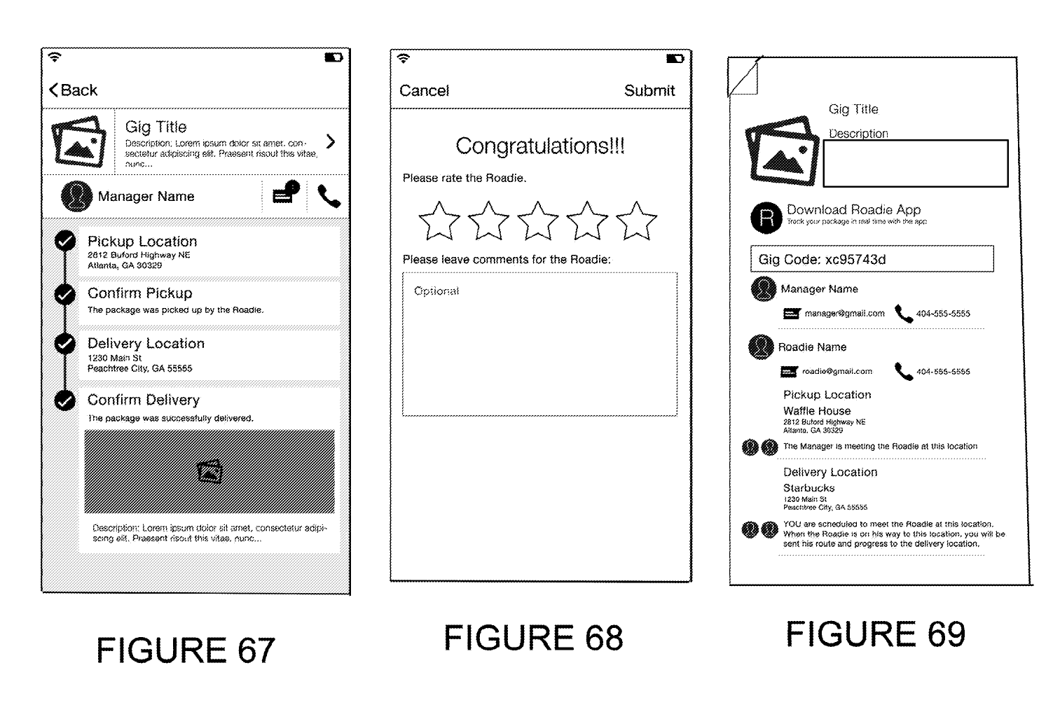

FIG. 67 is an exemplary mobile device screen illustrating a delivery confirmation screen for a sender, according to an embodiment.

FIG. 68 is an exemplary mobile device screen illustrating a rating screen for a driver used by the sender (or manager), according to an embodiment. The driver's ratings are averaged and displayed on the driver's profile (along with any specific comments). Note that in the figures “roadie” is synonymous with “driver.”

FIG. 69 is an exemplary mobile device screen illustrating a task information screen, according to an embodiment.

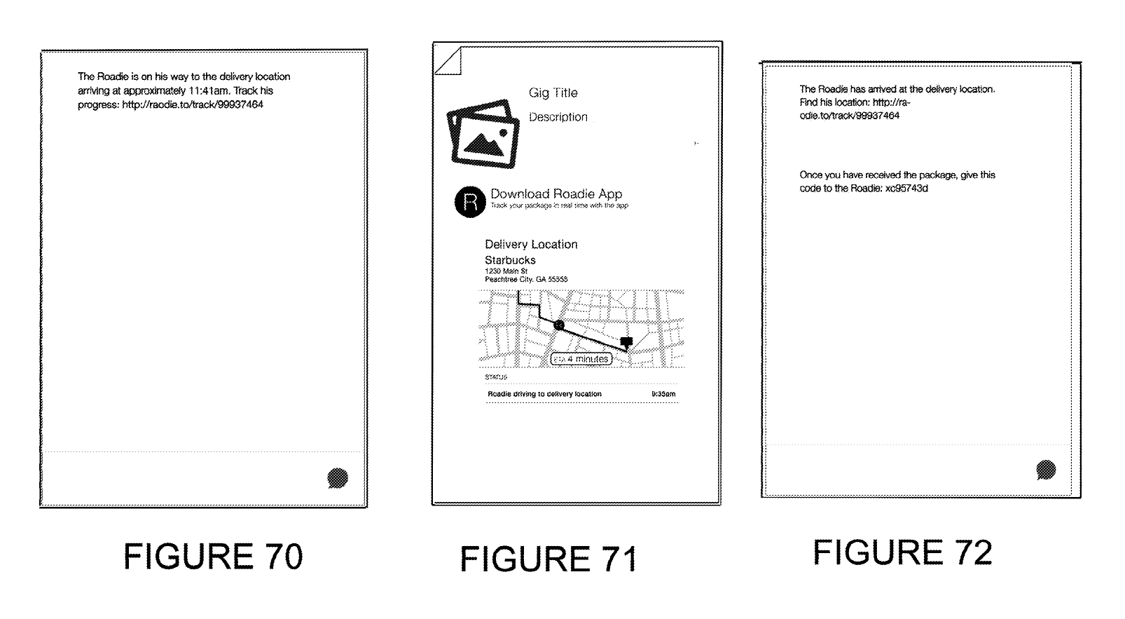

FIG. 70 is an exemplary mobile device screen illustrating an estimated delivery time, according to an embodiment.

FIG. 71 is an exemplary mobile device screen illustrating a delivery location screen, according to an embodiment.

FIG. 72 is an exemplary mobile device screen illustrating a delivery notification screen for the receiver, according to an embodiment. A code is given to the receiver which is then verbally communicated to the driver so that the driver can type in the code into the app running on the driver's mobile phone to verify the delivery.

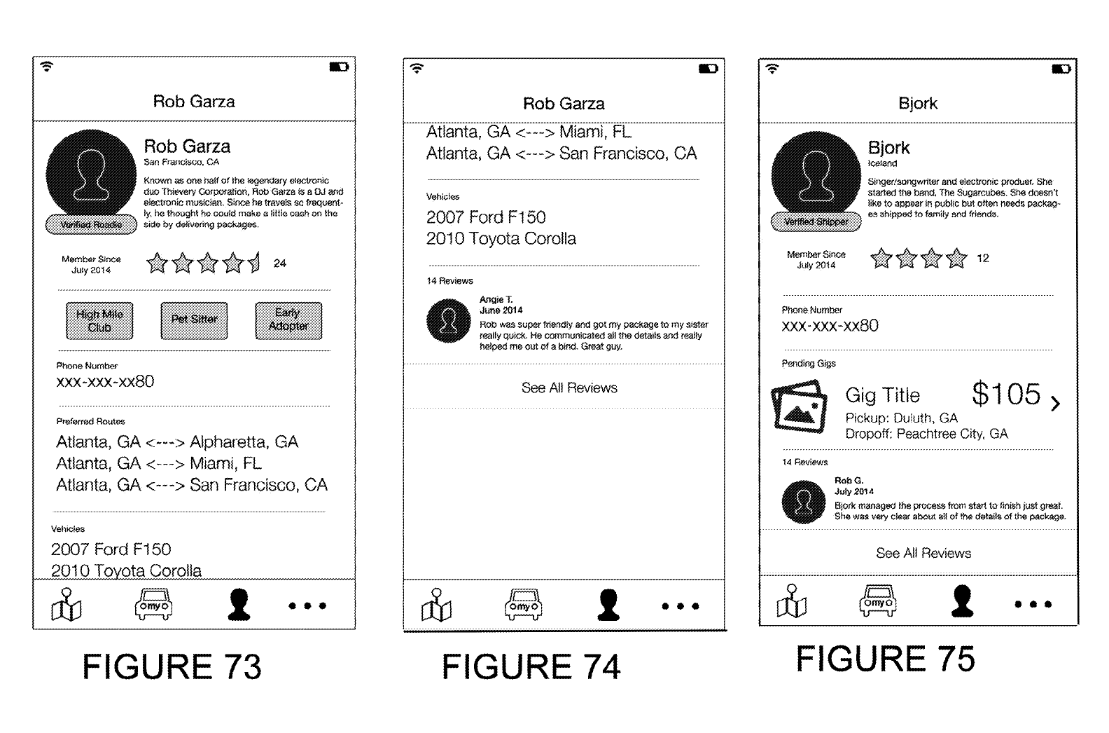

FIG. 73 is an exemplary mobile device screen illustrating a driver's profile screen, according to an embodiment.

FIG. 74 is an exemplary mobile device screen illustrating a driver's vehicles screen, according to an embodiment. All of the vehicles a driver has registered with the system (and can use for tasks) are listed.

FIG. 75 is an exemplary mobile device screen illustrating a sender's profile screen, according to an embodiment. Just like drivers have their own profiles, senders also have their own profiles as well so that drivers can learn about each sender.

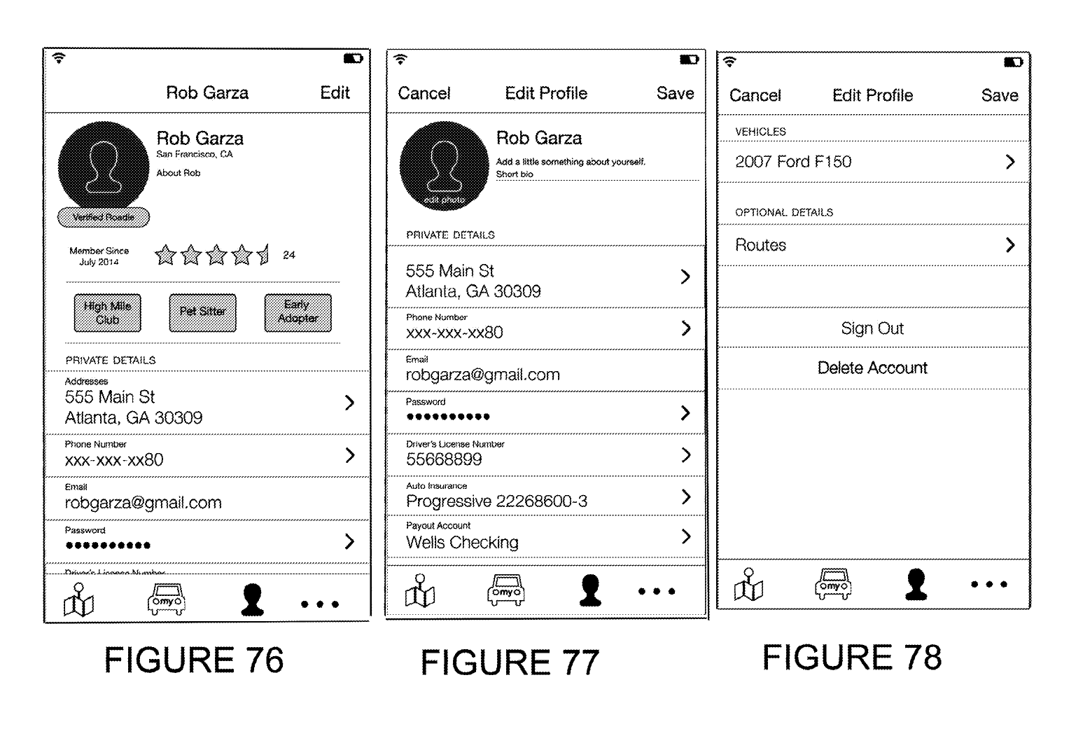

FIG. 76 is an exemplary mobile device screen illustrating a profile information screen from the user's viewpoint, according to an embodiment.

FIG. 77 is an exemplary mobile device screen illustrating a profile editing screen, according to an embodiment.

FIG. 78 is an exemplary mobile device screen illustrating a second portion of a profile editing screen, according to an embodiment.

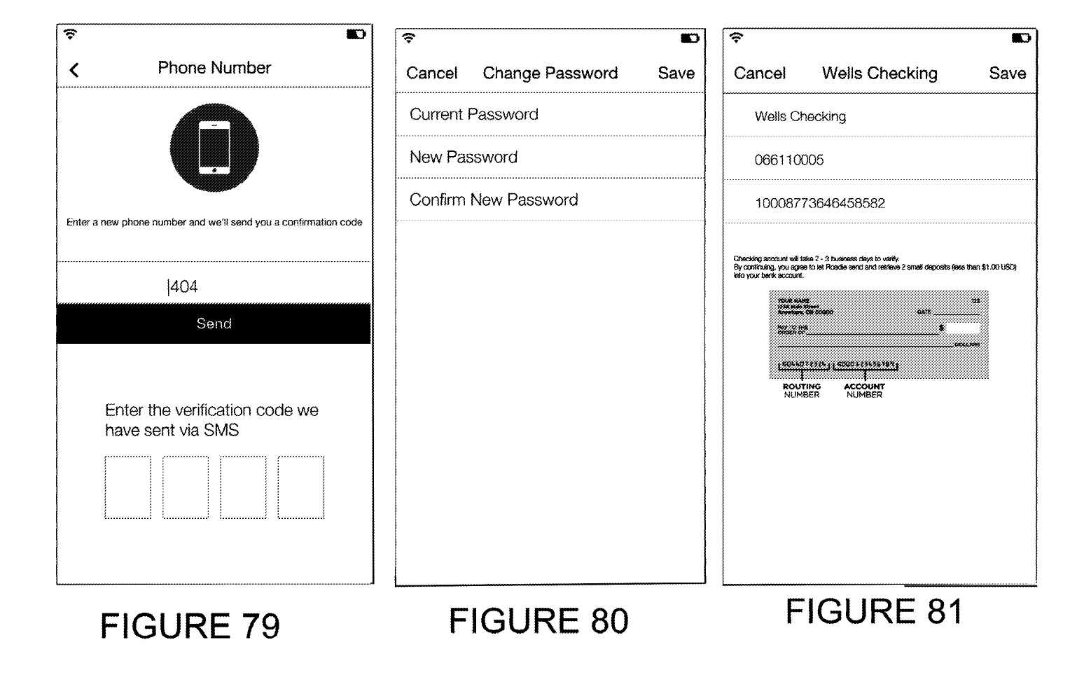

FIG. 79 is an exemplary mobile device screen illustrating a phone number editing screen with SMS verification, according to an embodiment. After the user enters their cell phone number, a number is texted to that number which the user types into this screen thereby verifying their cell phone number.

FIG. 80 is an exemplary mobile device screen illustrating a password editing screen, according to an embodiment.

FIG. 81 is an exemplary mobile device screen illustrating a checking information editing screen, according to an embodiment. A user enters their checking account in order to receive or make payments directly to/from their checking account.

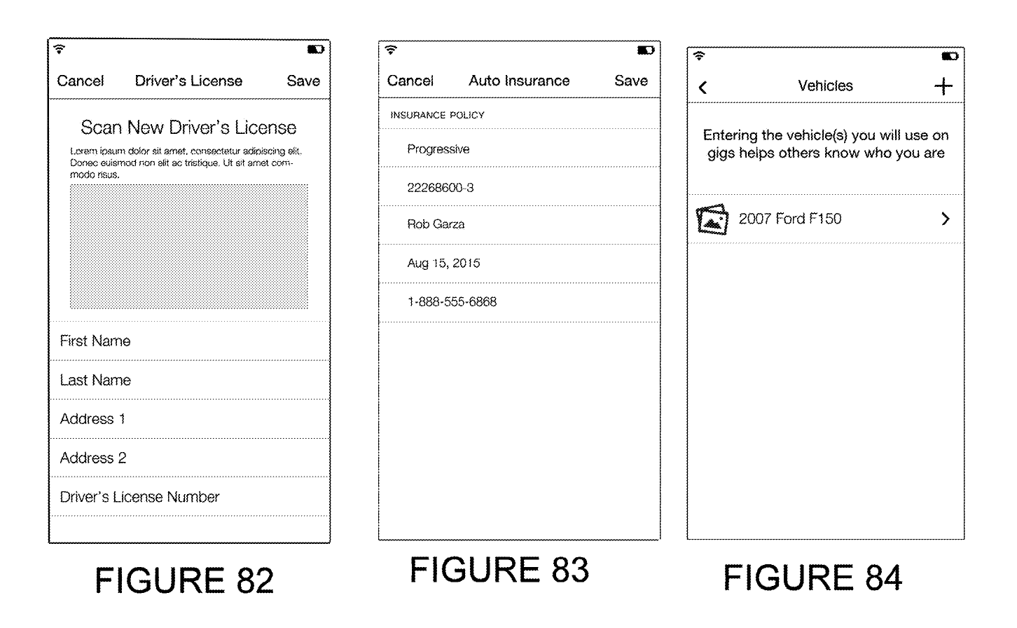

FIG. 82 is an exemplary mobile device screen illustrating a driver's license information editing screen, according to an embodiment. A database can be used in order to actually verify that the license is valid as well as the data (e.g., name, address, etc.) matches official motor vehicle records. If the driver's license cannot be confirmed, then the registration will not be confirmed at this time (and this user can actually participate in a task).

FIG. 83 is an exemplary mobile device screen illustrating an insurance information editing screen, according to an embodiment. A driver is required to enter his/her insurance information to verify that his/her vehicle is insured.

FIG. 84 is an exemplary mobile device screen illustrating a vehicle information editing screen, according to an embodiment. Each driver can enter the vehicles they will use, and for each task they will select one of their entered vehicles. Vehicles can be deleted as well.

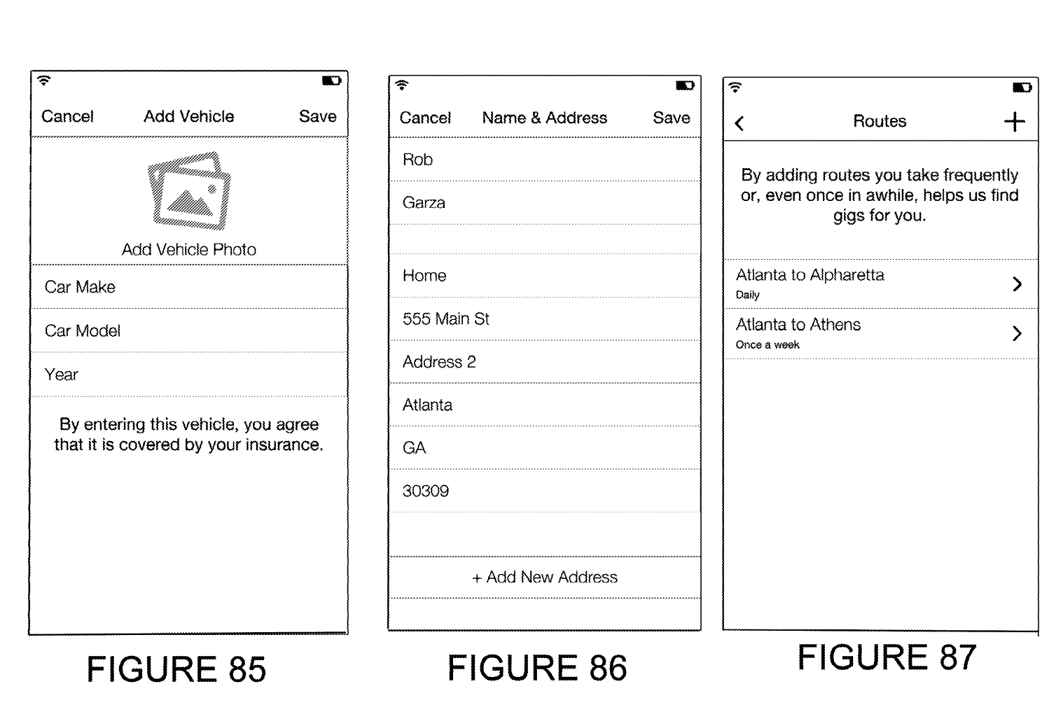

FIG. 85 is an exemplary mobile device screen illustrating a new vehicle information input screen, according to an embodiment.

FIG. 86 is an exemplary mobile device screen illustrating a personal information input screen, according to an embodiment. The user can add additional addresses here, like work, school, vacation, etc. If the user adds another address, the system should automatically create a route from the user's home to the new address (if the user is a driver so that this route can also be checked for potential deliveries, see FIG. 87).

FIG. 87 is an exemplary mobile device screen illustrating a route information editing screen, according to an embodiment. The driver enters routes the driver frequently drives (actual starting address to actual destination address) which are all stored in the driver's account. When tasks are being searched, these routes are also used to find tasks which are convenience to the driver's frequently travelled routes. Optionally, days of the week and/or times that the routes are taken can also be entered as well so that the routes can be given more weight when the current time matches the route's respective entered day/time.

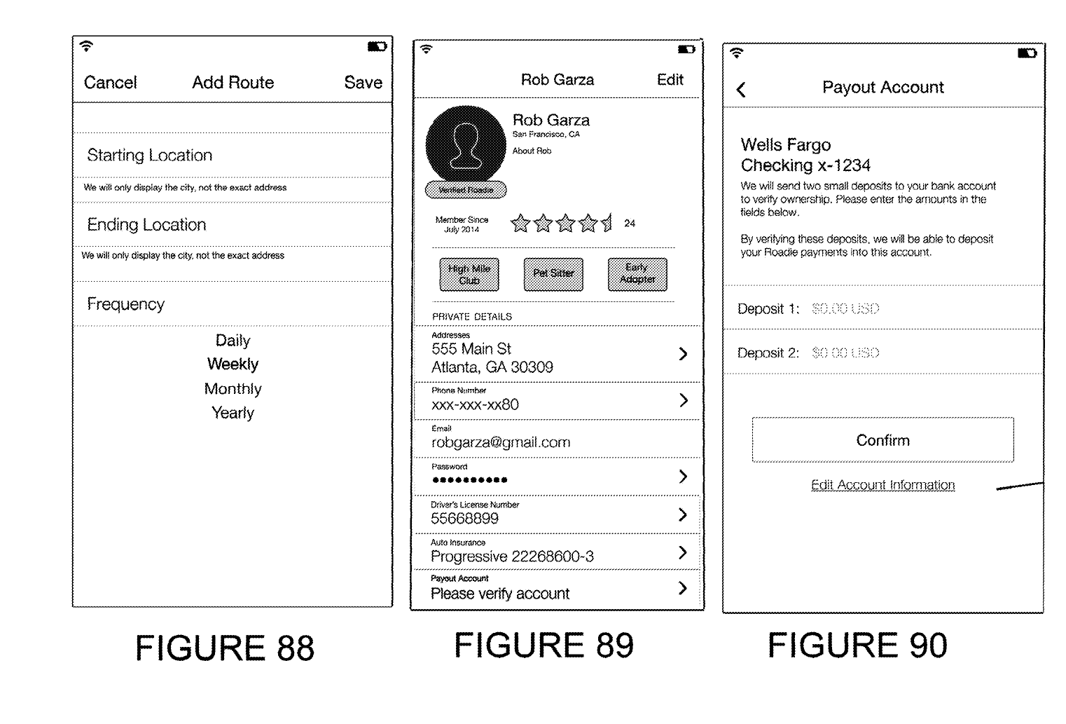

FIG. 88 is an exemplary mobile device screen illustrating a new route information input screen, according to an embodiment. The start and end locations can be actual addresses, but we will only show cities to the general public.

FIG. 89 is an exemplary mobile device screen illustrating a user information screen. The bottom entry “Please verify account” will be highlighted until the user's checking account is verified.

FIG. 90 is an exemplary mobile device screen illustrating a payment verification screen for ACH authorization, according to an embodiment. User must enter both deposits before the confirm button becomes active.

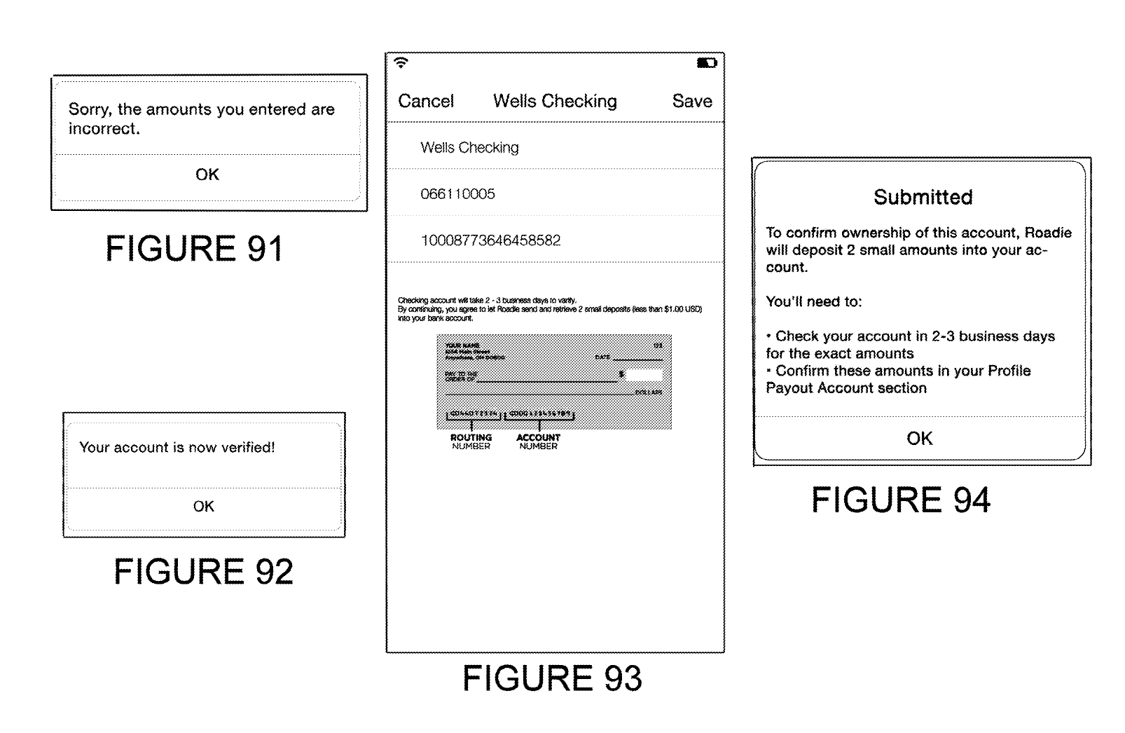

FIG. 91 is an exemplary mobile device screen illustrating an incorrect entering of verification information, according to an embodiment.

FIG. 92 is an exemplary mobile device screen illustrating a correct entering of verification information, according to an embodiment.

FIG. 93 is an exemplary mobile device screen illustrating a checking information editing screen for ACH authorization, according to an embodiment.

FIG. 94 is an exemplary mobile device screen illustrating checking account verification, according to an embodiment. The system will deposit one or more small amounts into the user's checking account and the user will enter those amounts into the system to verify the user is the actual owner of the checking account.

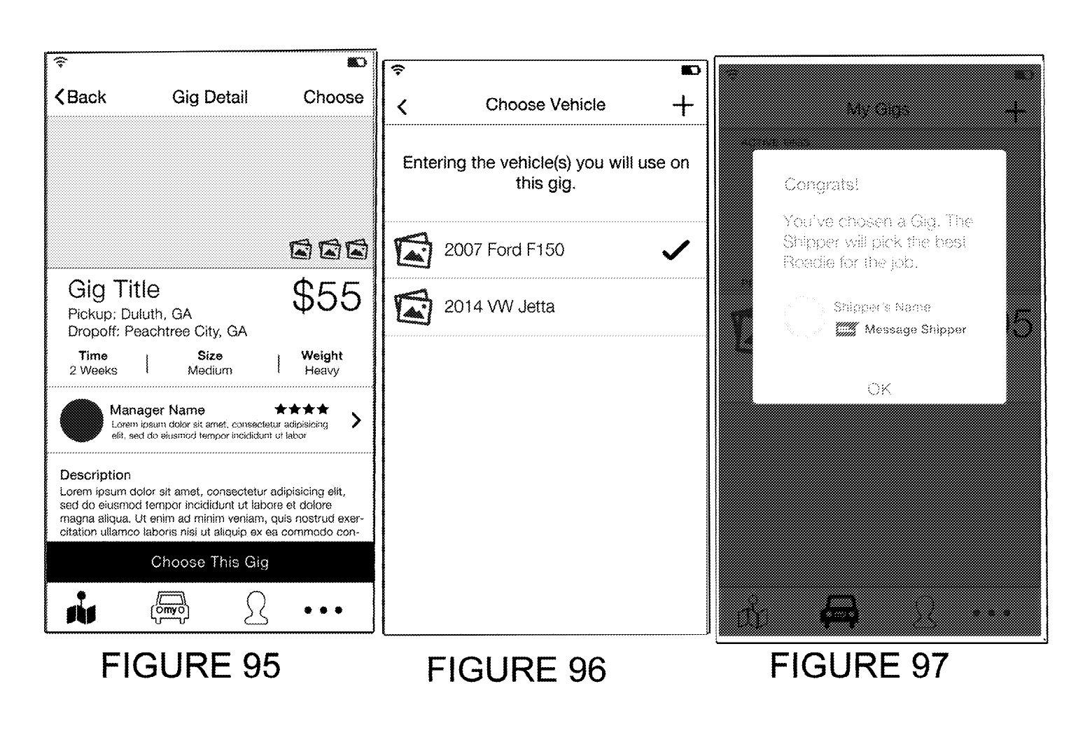

FIG. 95 is an exemplary mobile device screen illustrating a task information and selection screen, according to an embodiment. A driver can accept this task if the driver chooses.

FIG. 96 is an exemplary mobile device screen illustrating a vehicle selection screen, according to an embodiment. The driver can select which vehicle he/she will use for this task.

FIG. 97 is an exemplary mobile device screen illustrating a task confirmation screen, according to an embodiment. More than one driver may request to complete a task, and the user who requested the original task will then review all of the drivers who chose the task and select one to assign the task to.

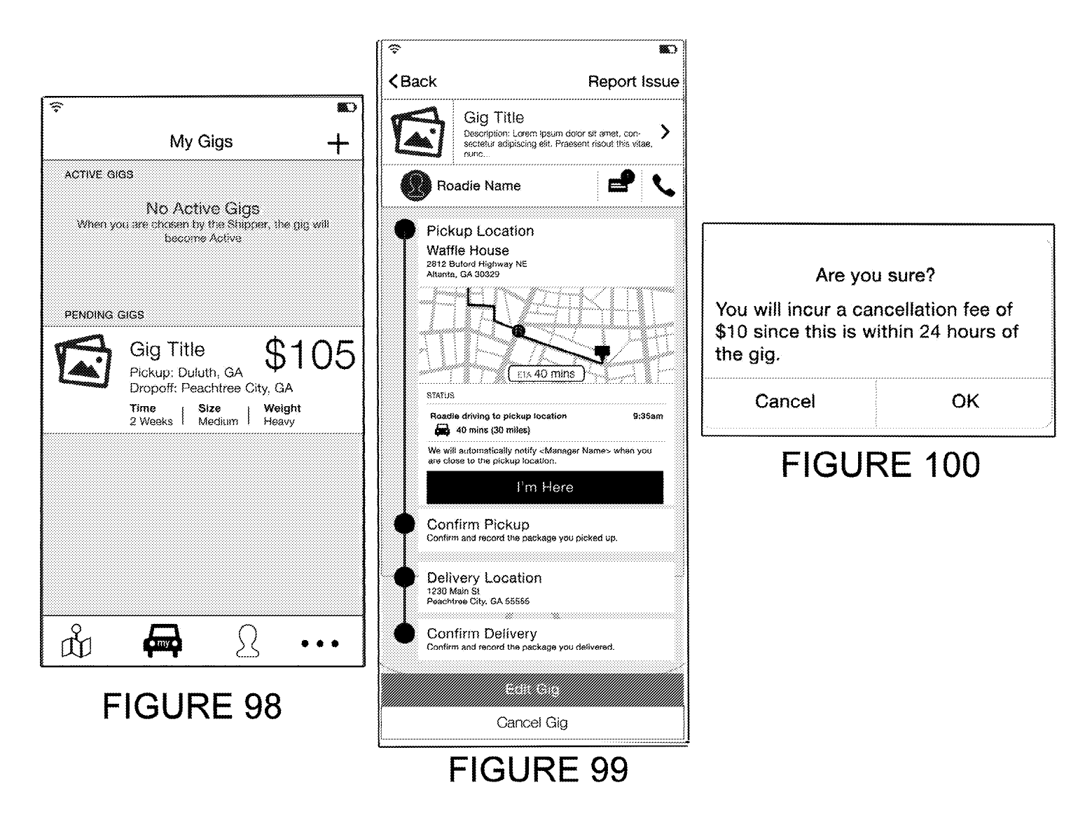

FIG. 98 is an exemplary mobile device screen illustrating an assigned task list screen, according to an embodiment. Once a task (gig) is chosen by the driver it shows up in the “pending gigs” (pending tasks) lists. If the task owner (user who posted the task) chooses this driver then the task is removed from the pending tasks list and put into the active tasks (active gigs) list. If this driver is not chosen for this task, then the task is removed from the pending task list (and not placed in the active task list) and the driver is informed that he/she was not chosen for that particular task.

FIG. 99 is an exemplary mobile device screen illustrating a detailed task display, according to an embodiment. When the driver is physically at the pickup location the driver can press the “I'm here” button to indicate to the system the driver is at the pickup location. The system tracks all statuses of tasks like this and will store the driver's current status of being present at the pickup location. The party who will be providing the package to the driver/deliverer at the pickup location (typically the sender) will be notified (e.g., via text message, etc.) that the driver is present at the pickup location.

FIG. 100 is an exemplary mobile device screen illustrating a task cancellation screen, according to an embodiment. A user (e.g., sender, manager) can cancel a task, and there will typically be a cancellation fee. Note that “shipper” is synonymous with “sender.” The user will receive this message before canceling the task completely.

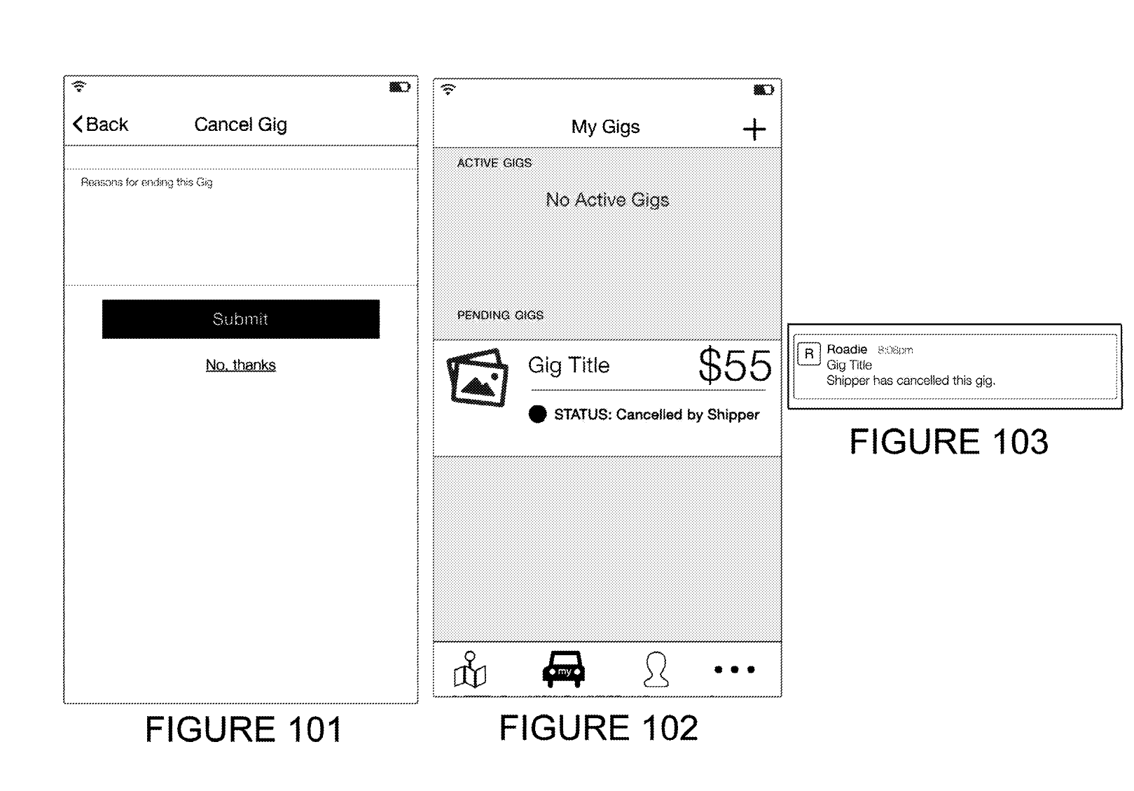

FIG. 101 is an exemplary mobile device screen illustrating a task cancellation screen for a driver, according to an embodiment. The user can enter reasons for the cancellation if the user wishes.

FIG. 102 is an exemplary mobile device screen illustrating a task that has been cancelled, according to an embodiment. This is a screen on the driver's device and the driver will see that the task has been canceled.

FIG. 103 is an exemplary mobile device screen illustrating a pop-up notification that a task has been cancelled, according to an embodiment.

Note that “server” as used herein refers to server 504 (which is also illustrated in more detailed as the production system 2700 in FIG. 27) which is maintained and configured by the entity that controls the entire peer to peer shipping system. This server can be programmed to perform all of the methods/features described herein including causing remote devices to perform and/or display any and all of the methods/features described herein. While the server 504 is illustrated as a single unit, it can be appreciated that this server can actually comprise more than one server operating together (either physically in the same location or different location with a virtual connection via the Internet or other computer communications network). Note that different devices can operate collaboratively to implement any features described herein. For example a first processing unit on a mobile phone displays a GPS map which is in communication with a second processing unit on the server which transmits data to the mobile phone (e.g., suggested delivery tasks, etc.) which can appear on the GPS. Thus, multiple processors are working together in order to effectuate any and all of the methods/features described herein. Note that any methods/features can also be performed by an app (e.g., software running on a portable computing device such as a cell phone) and any methods/features can also be running on the server, or methods/features can be split up in any combination between portable computing device and server. The word “causing” as used herein, can also comprise providing software/instructions to run on portable computing devices and also providing signals to the portable computing devices to take certain actions, even though these devices may be physically separate from the server. Thus, all of the methods/features herein are essentially caused by the server and any entity operating the server (which may distribute software for portable computing devices which allow the server to cause any methods/features on the portable computing devices).

All drivers (deliverers) should have a mobile phone (also referred to as portable computing device) that is capable is communicating wirelessly (e.g., cell phone calls) and also capable of download and running apps (such as an app programmed specifically to implement all features described herein) can also send/receive any type of data (including images, numbers, etc.) This type of mobile phone (that drivers should have) is commonly referred to as a “smart phone.” It is encouraged that other parties in the system (e.g., managers, receivers, senders) also have smart phones but it is not required.

Any description of a component or embodiment herein also includes hardware, software, and configurations which already exist in the prior art and may be necessary to the operation of such component(s) or embodiment(s). Further, the operations described herein can be performed in any sensible order. Any operations not required for proper operation can be optional. Further, all methods/features described herein can also be stored on a (non-transitory) computer readable storage medium to control a computer. Programs and/or data required to implement any of the methods/features described herein can all be stored (and executed therefrom to perform any of the methods/features) on any non-transitory computer readable storage medium (volatile or non-volatile, such as CD-ROM, RAM, ROM, EPROM, microprocessor cache, file storage, tape backup, data warehouse, etc.) Any database file storing any and all data described herein can also be stored in any such non-transitory computer readable storage medium. All methods/features described herein can also be combined with each other without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
causing one or more electronic processing units to perform:
maintaining a set of delivery tasks in an electronic database;
receiving an electronic request from a driver to generate a consolidation route comprising a starting point and a maximum time; and
generating the consolidation route, the consolidation route comprising a plurality of delivery tasks, wherein the consolidation route is geographically compatible with the starting point, wherein an estimated time to complete the consolidation route does not exceed the maximum time.

2. The method as recited in claim 1, wherein whether the consolidation route is geographically compatible with the starting point is satisfied when completion of the consolidation route does not require an excessive amount of additional time.

3. The method as recited in claim 2, wherein an excessive amount of time is satisfied by exceeding a predefined time threshold.

4. The method as recited in claim 1, wherein whether the consolidation route is geographically compatible with the starting point is satisfied when completion of the consolidation route does not require an excessive amount of additional miles.

5. The method as recited in claim 4, wherein an excessive amount of additional miles is satisfied by exceeding a predefined mileage threshold.

6. The method as recited in claim 1, wherein the request further comprises and ending point defining the driver's location when the consolidation route is completed.

7. The method as recited in claim 1, further comprising generating and displaying a set of proposed consolidation routes.

8. The method as recited in claim 7, further comprising displaying an hourly rate for the each respective consolidation route.

9. The method as recited in claim 7, wherein the request further comprises an amount of empty space in the driver's vehicle available for packages.

10. The method as recited in claim 1, further comprising, receiving an acceptance of the consolidation route by the driver, and displaying a navigation map with step by step directions which complete the consolidation route.

11. An apparatus, comprising:
one or more electronic processing units connected to a computer readable storage medium which stores computer readable instructions which are programmed to cause the one or more electronic processing units to:
maintain a set of delivery tasks;
receive a request from a driver to generate a consolidation route comprising a starting point and a maximum time; and
generate the consolidation route, the consolidation route comprising a plurality of delivery tasks, wherein the consolidation route is geographically compatible with the starting point, wherein an estimated time to complete the consolidation route does not exceed the maximum time.

12. The apparatus as recited in claim 11, wherein the instructions are further programmed such that whether the consolidation route is geographically compatible with the starting point is satisfied when completion of the consolidation route does not require an excessive amount of additional time.

13. The apparatus as recited in claim 12, wherein the instructions are further programmed such that an excessive amount of time is satisfied by exceeding a predefined time threshold.

14. The apparatus as recited in claim 11, wherein the instructions are further programmed such that whether the consolidation route is geographically compatible with the starting point is satisfied when completion of the consolidation route does not require an excessive amount of additional miles.

15. The apparatus as recited in claim 14, wherein the instructions are further programmed such that an excessive amount of additional miles is satisfied by exceeding a predefined mileage threshold.

16. The apparatus as recited in claim 11, wherein the instructions are further programmed such that the request further comprises and ending point defining the driver's location when the consolidation route is completed.

17. The apparatus as recited in claim 11, wherein the instructions are further programmed to cause operations of generate and display a set of proposed consolidation routes.

18. The apparatus as recited in claim 17, wherein the instructions are further programmed to cause an operation to display an hourly rate for the each respective consolidation route.

19. The apparatus as recited in claim 17, wherein the instructions are further programmed such that the request further comprises an amount of empty space in the driver's vehicle available for packages.

20. The apparatus as recited in claim 11, wherein the instructions are further programmed to receive an acceptance of the consolidation route by the driver, and display a navigation map with step by step directions which complete the consolidation route.
